(19) United States
(12) Patent Application Publication
(10) Pub. No.: US 2026/0270082 A1
(43) Pub. Date: Sep. 10, 2026

(54) BEI _24HWS A System for Multidimensional Behavioral Identity, Intention-Based Navigation, and Sovereign Domain-Terminal Operations

(71) Applicant: FURONG BEI, SAN GABRIEL, CA (US)

(72) Inventor: FURONG BEI, SAN GABRIEL, CA (US)

(21) Appl. No.: 19/178,867

(22) Filed: Apr. 15, 2025

(51) Int. Cl. H04L 9/32

(52) U.S. Cl. CPC H04L 9/3247; H04L 9/3236

(57) ABSTRACT

A rooted domain name-based behavioral economic identity, intention navigation, temporal trust routing, and domain terminal activation system is disclosed. A rooted domain identity module binds a BEI identity reference to a domain name, subdomain namespace, domain-based terminal address, registry handle, or decentralized namespace identifier. An intention navigation module generates an intention vector from a request event, and a temporal trust routing module maintains a temporal trust graph of domain-linked service endpoints. Candidate endpoints are retrieved, permission states are verified, temporal trust routing scores are computed, and a selected endpoint is activated through a domain terminal activation process. An ActionLedger stores signed route evidence and signed service evidence including identity, domain, intention, endpoint, permission, timestamp, verification, and ledger-state information. The architecture supports human, institutional, artificial-intelligence-agent, wallet, robot, vehicle, sensor, and Internet-of-Things nodes across multiple industries, including disconnected operation and later synchronization.

The title of the invention is Rooted Domain Name-Based BEI Behavioral Economic Identity, Intention Navigation, Temporal Trust Routing, and Domain Terminal Activation Systems and Methods. The disclosure concerns a rooted domain identity architecture in which a person, family, enterprise, institution, artificial-intelligence agent, wallet, robot, vehicle, sensor, Internet-of-Things device, or community terminal is associated with a BEI Behavioral Economic Identity reference and is routed through intention, time, trust, service capability, permission state, signed evidence, and domain terminal activation rather than through a platform account alone.

### CROSS-REFERENCE TO RELATED APPLICATIONS

Any claim of priority to, or benefit of, a prior U.S. provisional, nonprovisional, continuation, continuation-in-part, international, foreign, or related application should be set forth in the application data sheet, transmittal papers, or other official filing documents. This specification does not rely on a particular priority relationship unless such relationship is expressly identified in the official filing records.

### TECHNICAL FIELD

The invention relates to decentralized identity, rooted domain name identity, intention-based navigation, temporal trust routing, domain terminal activation, behavior-ledger processing, trust scoring, offline synchronization, permission-controlled endpoint execution, and cross-domain value relay. More particularly, the invention concerns a technical architecture in which a BEI-ID is bound to a rooted domain-linked terminal and used to coordinate identity verification, time-stamped behavior, intention routing, service activation, ActionLedger recording, TrustScore updating, value interface generation, and inter-domain relay across personal, institutional, physical, digital, and symbolic spaces.

The technical field includes identity and access management, domain name resolution, domain namespace management, personal data terminals, mobile and web service routing, distributed ledgers, cryptographic or signature-based confirmation, peer validation, emergency-resilient local-first synchronization, artificial-intelligence-assisted service selection, IoT command routing, wallet authorization, robot endpoint control, and privacy-limited verification. The system is not limited to a map display, a website, or a social profile; it is an integrated routing and terminal framework for connecting an authenticated BEI behavioral economic identity with services and records that may include medical, education, finance, insurance, logistics, agriculture, energy, legal, civic, household, robotic, and recovery functions.

The invention uses a rooted domain name or domain-based terminal address as a technical trust and routing anchor. The domain name is not merely a marketing address or passive website label. It functions as an addressable identity root, service namespace, control boundary, permission reference, continuity reference, and audit anchor through which behavioral records, intention routes, temporal states, terminal modules, recovery keys, signed evidence, value representations, and cross-system relay events can be organized, activated, and audited.

### BACKGROUND OF THE INVENTION

Existing digital identity systems are typically static, centralized, and externally issued. A user may hold a government identifier, platform account, telephone number, email address, device identifier, wallet address, or single sign-on credential, but these identifiers do not ordinarily provide a continuous behavioral identity that evolves across life stages, geography, institutions, service usage, and trusted relationships. The same person or entity may act through many disconnected accounts, and the historical behavior that gives the person or entity trust, capacity, skill, contribution, and continuity is not technically organized as a single rooted identity path.

Existing navigation systems begin with location, coordinates, roads, map layers, points of interest, or address destinations. A conventional navigation service can determine how a user may travel from a present location to a destination, but many human, machine, institutional, and service needs do not begin as a geographic destination. A requester may intend to obtain medical assistance, activate a family resource, prove a behavior, access an educational service, route a payment, trigger an emergency mode, authorize a wallet call, command an IoT gateway, delegate a robot operation, or activate a cross-domain credential. For those needs, a map route alone does not identify the relevant BEI identity, authority, trust state, temporal context, resource capacity, permission boundary, ledger record, or value pathway.

Existing service platforms solve isolated portions of this problem. A health platform may hold medical data, a bank may hold payment data, an educational platform may hold courses, an insurance portal may hold claims, a government portal may hold forms, a logistics platform may hold shipments, and a social platform may hold relationships. These systems generally remain platform-centric and siloed. They require the user to enter each silo and comply with the silo rules, and they do not provide a reusable rooted domain terminal that can host, relay, validate, and synchronize identity, behavior, trust, intention, service outcome, and value records across multiple fields.

Existing decentralized identity and blockchain systems provide wallet addresses, decentralized identifiers, or verifiable credentials, yet they often lack an intention navigation layer and a rooted domain terminal activation structure. A wallet address may identify control of a key, but it does not by itself route a request from an intention to a service path, does not organize a personal terminal containing medical, education, finance, governance, commerce, recovery, AI-agent, robot, wallet, and IoT modules, and does not necessarily provide domain-linked inheritance, offline behavioral ledger synchronization, temporal trust scoring, or behavior-frequency routing.

Existing artificial-intelligence agents can infer tasks, answer questions, call tools, or recommend services, but a generic agent does not by itself provide a rooted domain BEI identity, a temporal trust graph, a permission tree, signed route evidence, offline trust vault, or cross-domain continuity. Without such structure, an agent may become another silo or recommender. The present invention supplies the missing technical passage in which an intention is bound to BEI identity, rooted domain state, time, trust, permission, endpoint capability, activation, and evidence.

A need therefore exists for a technical system that binds a rooted domain identity to a programmable terminal and uses behavioral time, intention vectors, temporal trust graphs, routing score engines, action ledger entries, permission-controlled endpoint activation, offline synchronization, inheritance, recovery, privacy-limited verification, and cross-domain relay mechanisms to route a person, institution, agent, wallet, robot, device, or service terminal to services, resources, proofs, and value paths. The present invention addresses this need by providing a BEI-ID framework, an intention navigation engine, temporal trust routing, and a domain terminal activation system in a coherent architecture.

### SUMMARY OF THE INVENTION

The invention provides a rooted domain name-based behavioral economic identity and navigation infrastructure. In one aspect, a rooted domain identity module binds a BEI Behavioral Economic Identity reference to a rooted domain name, a subdomain namespace, a domain-based terminal address, a registry handle, or a decentralized namespace identifier. A behavioral identity state module generates and updates a behavioral identity vector from timestamped behavioral events, terminal interaction patterns, permission invocation events, service interactions, device telemetry, artificial-intelligence-agent interactions, wallet interactions, and cross-node communication events.

In another aspect, an intention navigation module generates an intention vector from a request event associated with a person, family, enterprise, institution, artificial-intelligence agent, robot, wallet, Internet-of-Things device, vehicle, sensor, or service terminal. The intention vector may include an intent class, demand category, urgency value, confidence value, time window, service class, endpoint class, policy scope, privacy flag, and domain-routing preference. The vector is not a mere natural language label; it is a machine-readable routing object used by the temporal trust routing module.

In another aspect, a temporal trust routing module maintains a temporal trust graph having nodes representing domain-linked service endpoints and edges representing time-valid trust relationships, permission relationships, availability states, service capability states, response-history states, and dispute states. A domain endpoint retrieval module retrieves candidate domain-linked service endpoints according to the intention vector and the temporal trust graph, and a routing score engine computes a temporal trust routing score according to urgency, temporal validity, trust weight, permission fit, endpoint availability, service capability, historical service quality, dispute status, privacy requirement, domain priority, and synchronization state.

In another aspect, a domain terminal activation module activates a selected domain-linked service endpoint according to the temporal trust routing score. Activation may cause an application programming interface call, wallet call, artificial-intelligence-agent tool call, Internet-of-Things command, robot instruction, message notification, service reservation, emergency alert, registry operation, or cross-domain relay. The activated endpoint can be human, institutional, software, wallet, robot, vehicle, sensor, IoT, or registry based.

In another aspect, an ActionLedger evidence module stores signed route evidence and signed service evidence. A signed route evidence record may include at least a BEI identity reference, domain identifier, intention vector hash, selected endpoint identifier, permission basis, route score, timestamp, cryptographic verification value, and ledger-state hash. The evidence structure allows later audit, dispute handling, trust score updating, privacy-limited verification, bounded rollback, offline reconciliation, value interface generation, and index updating.

The invention does not claim a natural law, mental process, or mere business arrangement. It is implemented through networked computing components, domain-resolution logic, identity modules, terminal modules, databases, user devices, local caches, synchronization agents, ledger entries, signature or time-stamp mechanisms, routing engines, scoring modules, endpoint directories, permission trees, and service interfaces. The technical improvement is the transformation of fragmented platform accounts and static domain names into a rooted, domain-linked, time-aware, behavior-validated, evidence-recorded navigation and terminal activation architecture.

### BRIEF DESCRIPTION OF THE DRAWINGS

FIG. 1 illustrates Overall Rooted Domain Intention Routing Architecture, including rooted domain BEI-ID, intention navigation engine, temporal trust routing, domain terminal activation, ActionLedger evidence, and trust/value feedback.

FIG. 2 illustrates BEI-ID State Generation and Domain Binding, including timestamped behavioral events, domain binding records, permission state, BEI identity state package, authentication output, and recovery or update output.

FIG. 3 illustrates Root Domain, Subdomain Namespace, and Permission Tree, including root domain, service namespaces such as bank, health, learn, energy, logistics, and agent, and a permission tree.

FIG. 4 illustrates Intention Vector Generation from Demand Classes, including request event, context extractor, demand classifier, intention vector, 999 demand classes, and 365 industry tags.

FIG. 5 illustrates Temporal Trust Graph Structure, including user, family, institution, AI agent, IoT, and service nodes with time-decayed edge weights.

FIG. 6 illustrates Domain Endpoint Retrieval and Candidate Selection, including intention vector, endpoint directories, candidate domain endpoint list, permission filter, and routable candidate set.

FIG. 7 illustrates Temporal Trust Routing Score Engine, including urgency, trust weight, permission fit, availability, service capability, dispute status, routing score engine, and ranked endpoint output.

FIG. 8 illustrates Domain Terminal Activation Runtime, including API calls, wallet calls, IoT commands, AI tool calls, service bookings, and registry operations.

FIG. 9 illustrates ActionLedger Signed Evidence Structure, including route evidence, service evidence, permission events, value events, dispute events, ledger-state hashes, and signatures.

FIG. 10 illustrates TrustScore Update and Time Decay, including service result, validation status, dispute outcome, trust score update with time decay, and updated trust edge.

FIG. 11 illustrates Offline Trust Vault and Mesh Resynchronization, including disconnected terminal, offline trust vault, peer receipts, reconnection decision, reconciliation, and Merkle verification.

FIG. 12 illustrates AI Agent, Robot, Wallet, and IoT Permission Routing, including scoped permission tree and permission-controlled endpoint activation for AI agents, robots, wallets, vehicles, sensors, and IoT gateways.

FIG. 13 illustrates Cross-Industry Endpoint Implementation Matrix, including medical, education, finance, logistics, agriculture, energy, legal, civic, insurance endpoints and a common route core.

FIG. 14 illustrates Domain Inheritance, Recovery, and Delegation, including predecessor domain, trigger or recovery rule, key rotation, successor domain, and continuity evidence.

FIG. 15 illustrates Privacy-Limited Verification and Bounded Rollback, including raw behavioral evidence, privacy filter, limited proof, dispute state, and bounded rollback state.

FIG. 16 illustrates BEIMINT, TimeCurrency, BEICurrency, and BEIIndex Interface, including signed contribution, BEIMINT interface, TimeCurrency or BEICurrency value representation, BEIIndex update, and value/index output.

FIG. 17 illustrates Multi-Industry Use Case Loop, including rooted domain intention route core, medical alerts, learning requests, payment needs, sensor alerts, care requests, shipment exceptions, and activated domain endpoint.

FIG. 18 illustrates Cross-Protected Asset and Service Layer Topology, including domain assets, patent claims, terminal software, API or SDK, industry modules, evidence ledger, and index/value layer.

### DEFINITIONS AND CORE CONCEPTS

BEI-ID refers to a BEI Behavioral Economic Identity reference associated with a person, family, enterprise, institution, organization, community, artificial-intelligence agent, wallet, robot, vehicle, sensor, IoT device, or service terminal. The BEI-ID is programmable because it can be updated by validated behavior, intention events, trust events, terminal actions, permissions, signed evidence, and domain-linked records.

Rooted domain name refers to a domain-linked identity root that provides a persistent addressable namespace for a terminal. The domain may be a public domain, subdomain, application domain, registry handle, domain alias, private namespace, decentralized namespace identifier, domain-based terminal address, or equivalent resolvable naming node. The rooted domain name can serve as a trust anchor, access point, service namespace, inheritance reference, terminal endpoint, permission boundary, and audit reference.

Domain terminal refers to a terminal associated with a rooted domain name and BEI-ID. The terminal may be implemented as a web portal, mobile application, local device, wearable gateway, software container, personal server, domain endpoint, institutional endpoint, robot controller, wallet interface, IoT gateway, or multi-module service hub.

Intention vector refers to a machine-readable routing object generated from a request event. The vector may contain intent class, demand category, urgency, confidence, time window, service class, endpoint class, policy scope, privacy flag, and domain-routing preference. The vector may be derived from user input, voice, text, sensor state, scheduled task, medical or service request, terminal action, or AI-assisted interpretation.

Temporal trust graph refers to a graph containing nodes and edges that change over time. Nodes may represent users, families, enterprises, medical resources, educational resources, financial resources, logistics resources, agriculture resources, energy resources, insurance resources, legal resources, civic resources, AI agents, robots, wallets, vehicles, sensors, registries, and service terminals. Edges may represent trust weights, validation status, response latency, dispute outcome, time-decay values, permissions, availability, endpoint capacity, and service quality.

RTTNav and TimeNav refers to routing components that evaluate relational trust, behavior-frequency, time context, temporal validity, life stage, schedule window, emergency state, deadline, recurrence, and time-zone alignment. Together, RTTNav x TimeNav provides intention-based navigation through identity, behavior, trust, and time rather than only through geographic coordinates.

ActionLedger refers to an evidence structure that receives signed route evidence, signed service evidence, permission events, value events, dispute events, recovery events, contribution events, and synchronization records. It may be implemented by a conventional database, append-only log, hash chain, Merkle tree, directed acyclic graph, local ledger, distributed ledger, signed event stream, or hybrid structure.

TrustScore refers to a score, vector, matrix, graph state, or permission model derived from repeated behavioral credibility, peer confirmation, institutional confirmation, service completion, dispute status, time consistency, response quality, recovery events, and other trusted indicators. TrustScore may govern routing, permissions, escalation, rewards, arbitration, certification, and service eligibility.

Domain terminal activation refers to execution of a selected endpoint after the route score and permission basis have been evaluated. Activation may include API call, wallet call, AI tool call, IoT command, robot instruction, message notification, service reservation, emergency alert, registry operation, service module opening, or cross-domain relay.

Inter-domain relay refers to a bridge, message, credential, token, proof, API payload, encrypted package, ledger reference, or protocol by which behavioral assets, credentials, trust states, terminal instructions, service records, or value representations move from one domain terminal to another while preserving source domain, identity, time, permission, trust, and evidence metadata.

Value representation refers to a time token, trust token, BEIMINT record, TimeCurrency unit, BEICurrency unit, credit, voucher, settlement record, wallet entry, index contribution, or other representation derived from validated behavior, service contribution, data authorization, resource exchange, or terminal activity tied to BEI identity, rooted domain, time, and evidence.

### System Architecture

In one implementation, the system includes an identity layer, domain layer, terminal layer, intention navigation layer, temporal trust graph layer, endpoint directory layer, routing score layer, permission layer, terminal activation layer, ActionLedger evidence layer, TrustScore feedback layer, offline synchronization layer, inheritance and recovery layer, privacy verification layer, value and index interface layer, and inter-domain relay layer. The layers may be distributed across user devices, servers, domain resolution systems, local caches, institutional systems, peer validation networks, cloud services, edge nodes, hardware gateways, and device interfaces.

The identity layer binds a requester or endpoint to a BEI-ID. The binding may be created by registration, invitation, inheritance, institutional onboarding, device provisioning, credential import, wallet association, robot commissioning, IoT gateway setup, domain claim, or validated behavior. The BEI-ID may be associated with keys, recovery contacts, biometric factors, behavioral patterns, institutional proofs, service histories, permissions, and domain terminal records. The identity layer does not require a single centralized issuer because trust may be built through repeated validated behavior and signed domain-linked records.

The domain layer binds the BEI-ID to a rooted domain name or equivalent domain-based terminal address. The domain may identify a personal terminal, family terminal, community terminal, institutional terminal, enterprise terminal, medical terminal, education terminal, financial terminal, logistics terminal, energy terminal, insurance terminal, legal terminal, civic terminal, wallet terminal, robot terminal, sensor terminal, or IoT gateway. The system may maintain signed binding records that map the domain to terminal modules, endpoint directories, service pointers, permission rules, key identifiers, controller roles, and validity metadata.

The intention navigation layer receives a request event and generates an intention vector. The route may be a module route, service route, person route, institutional route, data route, geographic route, value route, recovery route, emergency route, machine route, or relay route. The layer evaluates user role, time, trust score, behavior history, urgency, location when relevant, device state, data permissions, endpoint capability, privacy requirement, and service availability. Geographic maps may be called as subordinate services, but the invention is not limited to geographic navigation.

The temporal trust graph layer maintains graph nodes and edges that change with time, validation, service outcome, dispute state, and availability. A high-priority emergency intent may use a different route than a routine appointment intent, even for the same BEI-ID and domain root. A route can also change when an endpoint becomes unavailable, an edge decays over time, a validator updates a service-quality value, or a permission tree changes because of delegation or recovery.

The domain endpoint retrieval layer obtains candidate endpoints from DNS records, subdomain records, registry records, decentralized namespace records, service pointer records, local terminal caches, mesh-node directories, peer-receipt directories, institutional directories, device registries, wallet interfaces, and IoT gateway records. Candidate retrieval is filtered by intention class, domain-routing preference, service class, endpoint class, permission state, and privacy flag before scoring is applied.

The routing score layer computes a temporal trust routing score for each candidate endpoint. The score may be based on urgency, temporal validity, trust weight, permission fit, endpoint availability, service capability, historical service quality, response latency, dispute status, privacy requirement, domain priority, synchronization state, and domain-specific policy. The score may be scalar, vector, matrix, or graph-based, and different scoring functions may be used for medical, education, finance, logistics, insurance, legal, civic, robot, wallet, IoT, or recovery routes.

The terminal activation layer activates the selected endpoint and produces a machine state change. A terminal may open a service module, call an API, generate a wallet authorization, issue an IoT command, send a robot instruction, book a service, trigger an emergency notification, update a registry, create a message, invoke an AI tool, or relay a credential. The activation result is not merely displayed; it is recorded as signed evidence with identity, domain, intention, endpoint, permission, time, verification, and ledger-state information.

The ActionLedger evidence layer records signed route evidence, signed service evidence, permission events, value events, dispute events, recovery events, and synchronization events. Records may be confirmed, provisional, disputed, synchronized, expired, revoked, inherited, or privacy-limited. The ledger may be partitioned by module, domain, time range, or privacy level, so a health route can restrict certain raw records while a public governance route can publish selected decision records.

The feedback layer updates TrustScore, permission state, endpoint capability, route history, value representation, or index state according to the result. If a route completes successfully and is validated by peers, institutions, devices, service providers, or signatures, trust weight may increase. If a route fails or becomes disputed, the endpoint may be down-ranked, constrained, or placed into review. This feedback makes the system adaptive while preserving auditability.

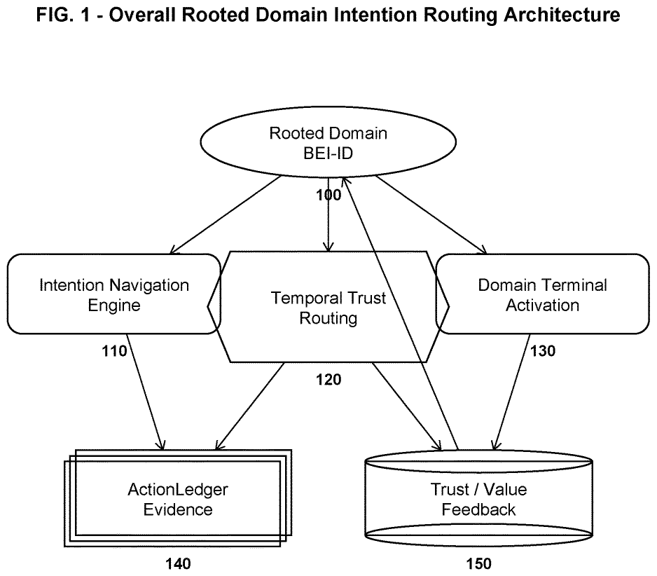

### Implementation of FIG. 1: Overall Rooted Domain Intention Routing Architecture

FIG. 1 shows a non-limiting implementation of Overall Rooted Domain Intention Routing Architecture. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

A request begins at a rooted domain BEI-ID and is processed by an intention navigation engine. The engine generates a structured intention state and passes it to temporal trust routing. The selected route activates a domain terminal endpoint and produces ActionLedger evidence. Trust and value feedback then update later route selection. This flow converts a domain-linked request from a static address lookup into a verified identity-to-intention-to-trust-to-endpoint route.

The architecture supports personal, family, enterprise, institutional, AI-agent, wallet, robot, sensor, IoT, and community terminals. In each case, the rooted domain provides continuity, the BEI-ID provides behavioral identity, the intention engine provides machine-readable demand state, the temporal trust router provides route selection, and the ActionLedger provides audit evidence.

The implementation shown in FIG. 1 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

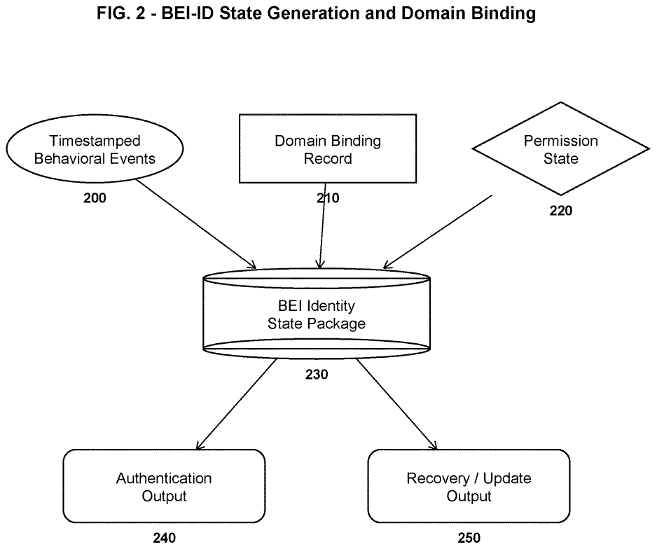

### Implementation of FIG. 2: BEI-ID State Generation and Domain Binding

FIG. 2 shows a non-limiting implementation of BEI-ID State Generation and Domain Binding. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The BEI-ID state generation process receives timestamped behavioral events, domain binding records, and permission states. The output may be a BEI identity state package used for authentication, route selection, recovery, update, delegation, and service eligibility. The identity state may include behavior-history hash, role state, domain-bound identity value, trust weight, recovery state, privacy flag, and policy version.

This process differs from ordinary login because the identity state is not limited to a username and password. The state evolves from verified behavior and domain terminal activity. When service interactions, agent interactions, wallet interactions, sensor data, or cross-node communications occur, the system can update the BEI identity vector and preserve the update as signed evidence.

The implementation shown in FIG. 2 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

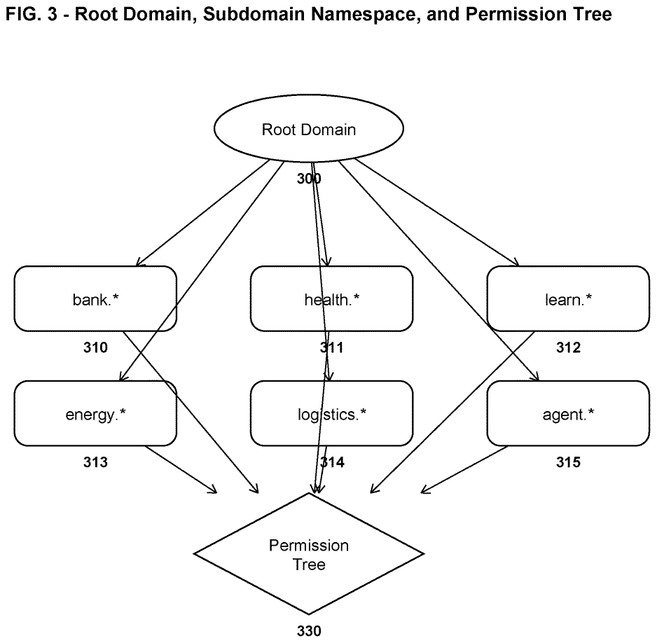

### Implementation of FIG. 3: Root Domain, Subdomain Namespace, and Permission Tree

FIG. 3 shows a non-limiting implementation of Root Domain, Subdomain Namespace, and Permission Tree. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The root domain, subdomain namespace, and permission tree allow a single rooted identity terminal to expose multiple service namespaces. Examples include bank, health, learn, energy, logistics, and agent namespaces, although other domains and namespaces may be used. A permission tree can determine whether a BEI-ID, family node, institutional role, AI agent, wallet, robot, sensor, or service terminal may activate a particular namespace or operation.

The namespace is not treated as a mere website taxonomy. It is part of the technical route because it defines where service endpoints are located, what permissions are required, which policy set applies, and how route evidence is indexed. A competitor that changes the label to a private namespace, application endpoint, or decentralized namespace can still implement the same technical relationship if the namespace functions as the rooted identity terminal.

The implementation shown in FIG. 3 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

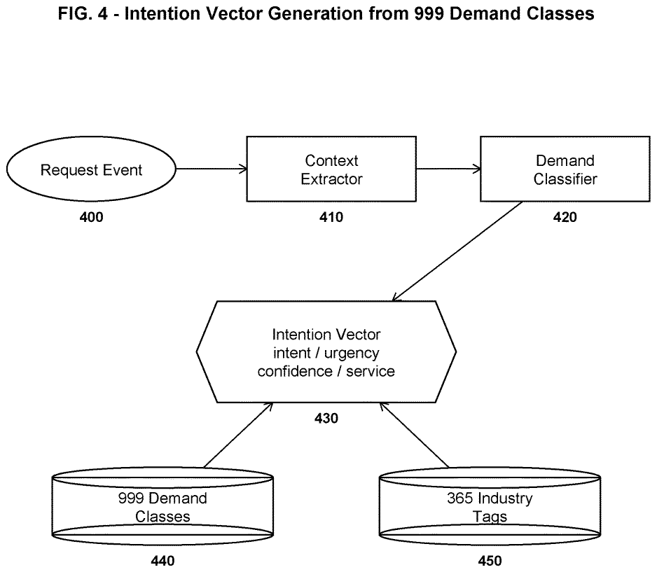

Implementation of FIG. 4: Intention Vector Generation from Demand Classes

FIG. 4 shows a non-limiting implementation of Intention Vector Generation from 999 Demand Classes. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The intention vector generation process converts a request event into structured routing data. A context extractor may identify source, requester, time, device, language, service class, urgency, confidence, privacy requirement, and domain preference. A demand classifier may map the request into demand classes and industry tags, and the output intention vector can be used by the temporal trust routing engine.

The demand classes and industry tags are not claimed as a fixed list unless expressly recited. They illustrate that an intention can be routed across many service fields, including medical care, learning, payment, sensor alert, care request, shipment exception, insurance event, legal task, civic request, or energy service. The important technical feature is the generation of a machine-readable intention vector that can be scored against domain-linked endpoints.

The implementation shown in FIG. 4 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

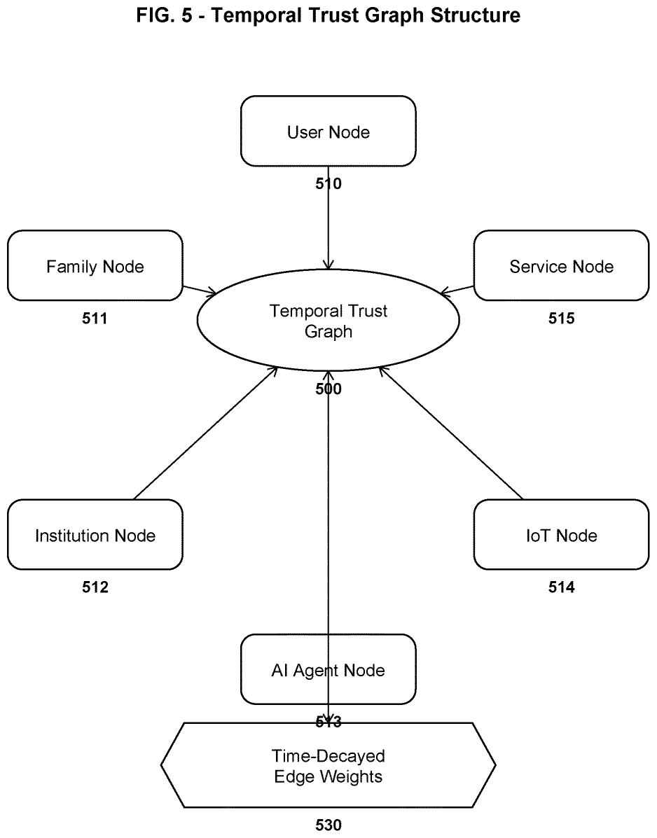

### Implementation of FIG. 5: Temporal Trust Graph Structure

FIG. 5 shows a non-limiting implementation of Temporal Trust Graph Structure. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The temporal trust graph contains nodes representing users, families, institutions, AI agents, IoT devices, service providers, and other endpoints. Edges are weighted by trust, permission, availability, service quality, response history, dispute outcome, and time decay. The graph may be stored centrally, distributed across terminals, cached locally, or reconstructed from ActionLedger evidence and endpoint directories.

Time decay changes route selection because an old service confirmation, stale availability signal, expired permission, or unresolved dispute may not carry the same weight as a current state. The graph may therefore prefer a lower-distance but lower-trust endpoint in one situation and a higher-trust but more remote endpoint in another. This distinguishes the invention from route selection based solely on geographic proximity.

The implementation shown in FIG. 5 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

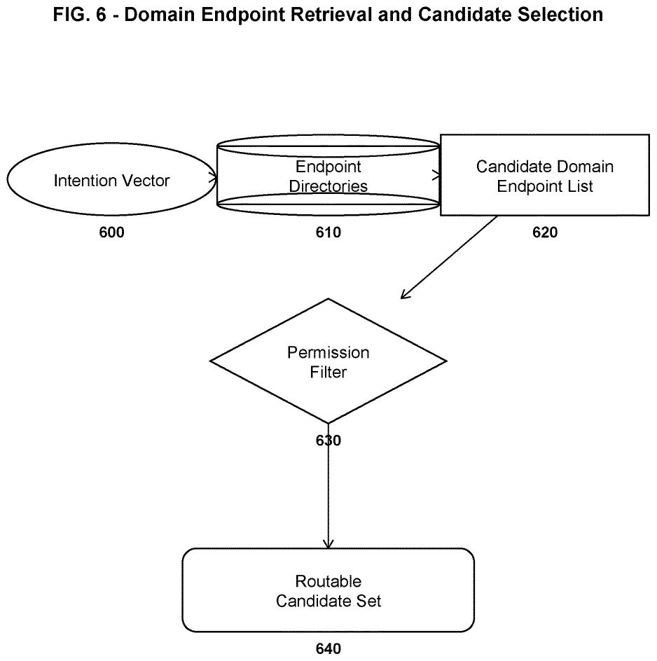

### Implementation of FIG. 6: Domain Endpoint Retrieval and Candidate Selection

FIG. 6 shows a non-limiting implementation of Domain Endpoint Retrieval and Candidate Selection. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

Candidate endpoint retrieval identifies domain-linked endpoints that may satisfy the intention vector. Endpoint directories may include DNS records, subdomain records, registry records, decentralized namespace records, service pointer records, local terminal caches, mesh-node directories, peer-receipt directories, and institutional or device registries. A permission filter removes endpoints that lack sufficient authority, consent, capability, or privacy compatibility.

The routable candidate set is the set of endpoints remaining after retrieval and permission filtering. The system can then rank this set through temporal trust routing. By separating retrieval, permission filtering, scoring, and activation, the architecture provides support for written description and allows different industries to use different endpoint directories without changing the core route mechanism.

The implementation shown in FIG. 6 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

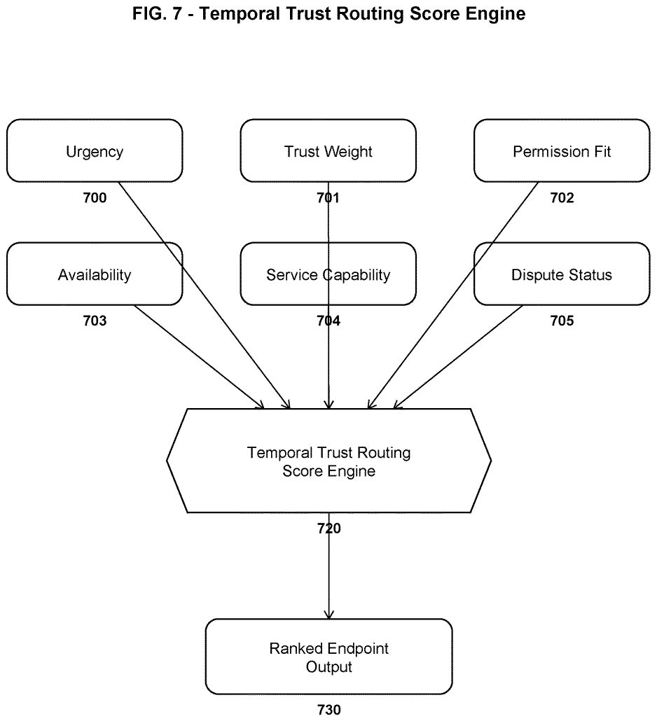

### Implementation of FIG. 7: Temporal Trust Routing Score Engine

FIG. 7 shows a non-limiting implementation of Temporal Trust Routing Score Engine. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The routing score engine may receive urgency, trust weight, permission fit, availability, service capability, dispute status, temporal validity, historical service quality, privacy requirement, domain priority, and synchronization state. The score may be computed as a weighted scalar, vector, graph path value, rule-based score, machine-learned score, or hybrid score. The computed score is stored or hashed so the route can be audited later.

The score engine is a central anti-design-around feature. A competitor may describe the system as matching, dispatch, triage, smart routing, AI recommendation, or task assignment. If the process uses rooted domain identity, intention state, temporal trust graph information, permission state, route scoring, endpoint activation, and signed evidence, it follows the disclosed technical passage.

The implementation shown in FIG. 7 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

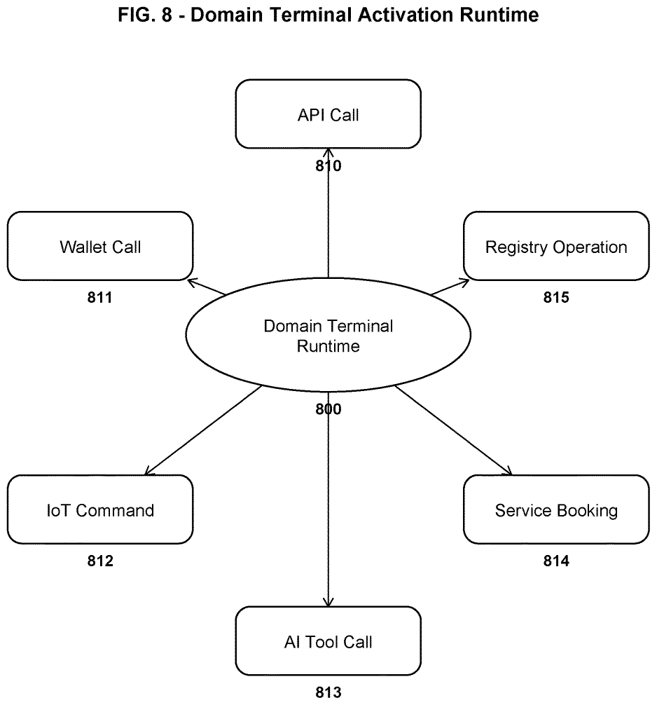

### Implementation of FIG. 8: Domain Terminal Activation Runtime

FIG. 8 shows a non-limiting implementation of Domain Terminal Activation Runtime. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The domain terminal activation runtime converts the selected route into execution. Depending on endpoint class, activation may include an API call, wallet call, IoT command, AI tool call, robot instruction, service booking, registry operation, message notification, emergency alert, or cross-domain relay. The activation runtime may run on a user device, hosted container, browser terminal, mobile terminal, edge node, or institutional gateway.

Activation is constrained by permission state and evidence generation. For example, a wallet call may require scoped authorization, a robot instruction may require safety permissions, an IoT command may require gateway confirmation, a medical service booking may require consent, and a registry operation may require a signed domain-terminal binding record. The terminal records the selected operation and result in the ActionLedger.

The implementation shown in FIG. 8 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

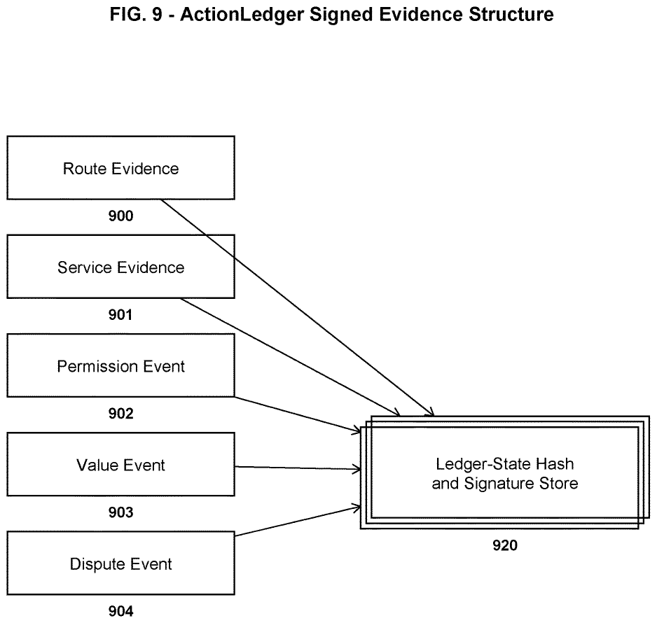

### Implementation of FIG. 9: ActionLedger Signed Evidence Structure

FIG. 9 shows a non-limiting implementation of ActionLedger Signed Evidence Structure. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The ActionLedger signed evidence structure may store route evidence, service evidence, permission events, value events, and dispute events. Each entry may include identity, domain, intention, endpoint, permission, timestamp, source, validator, signature, cryptographic verification value, ledger-state hash, and status. Entries may be confirmed, provisional, disputed, synchronized, expired, revoked, inherited, or privacy-limited.

The ledger-state hash and signature store allow later verification without requiring every raw behavioral record to be disclosed. A limited proof may show that a route was authorized and recorded while preserving private details. This provides a technical basis for privacy-limited verification, dispute review, bounded rollback, value conversion, and index updating.

The implementation shown in FIG. 9 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

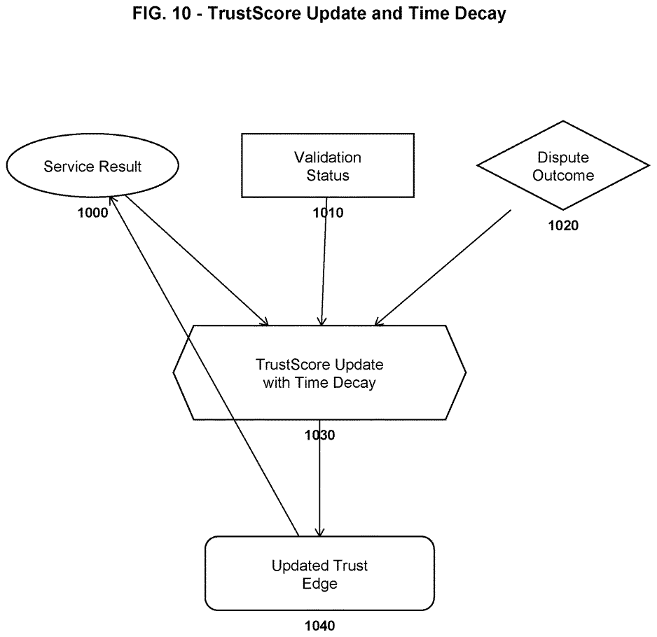

### Implementation of FIG. 10: TrustScore Update and Time Decay

FIG. 10 shows a non-limiting implementation of TrustScore Update and Time Decay. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The TrustScore update and time decay process receives service result, validation status, and dispute outcome. A successful service result may increase a trust edge, a failed or disputed service may reduce priority, and an old confirmation may decay over time. Different modules may have different trust models; a medical route may emphasize clinical confirmation while a logistics route may emphasize delivery performance and response latency.

TrustScore is not limited to a single number. It may be a vector, matrix, graph state, edge weight, permission state, or set of policy values. Updating TrustScore feeds back into the temporal trust graph and changes later routing. This feedback loop produces a technical effect beyond static directory lookup or ordinary search ranking.

The implementation shown in FIG. 10 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

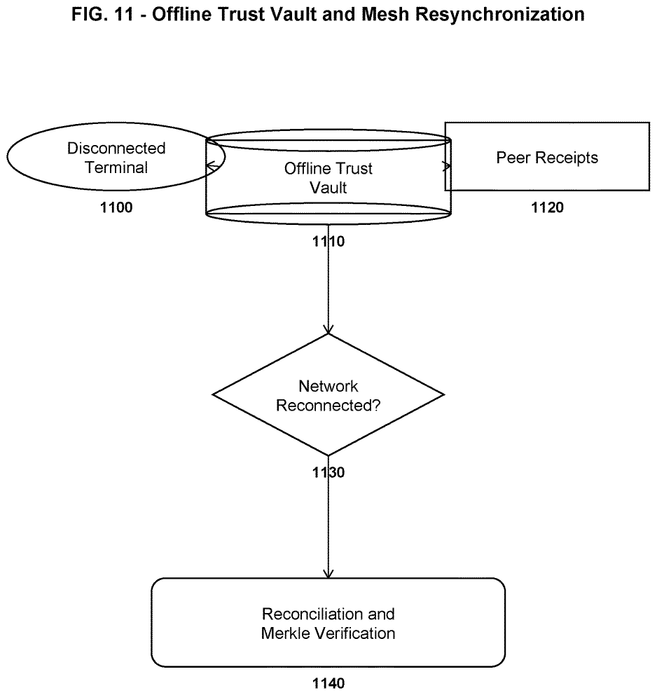

### Implementation of FIG. 11: Offline Trust Vault and Mesh Resynchronization

FIG. 11 shows a non-limiting implementation of Offline Trust Vault and Mesh Resynchronization. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The offline trust vault supports disconnected operation. When a terminal is disconnected, the system may cache a request event, intention vector, candidate endpoint state, local route score, selected endpoint, local signature, peer receipt, conflict flag, and ledger-state hash. When the network is reconnected, records are reconciled by timestamp ordering, signature verification, quorum confirmation, conflict-free replicated data type rule, domain-priority rule, permission-priority rule, Merkle proof, or bounded rollback rule.

Offline trust vault operation is important for disaster zones, remote service areas, mobile users, field workers, medical care, logistics operations, and community governance. The terminal can continue to record behavior and service events without treating disconnected time as empty or unverified. Later reconciliation preserves continuity while still marking conflicts for review.

The implementation shown in FIG. 11 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

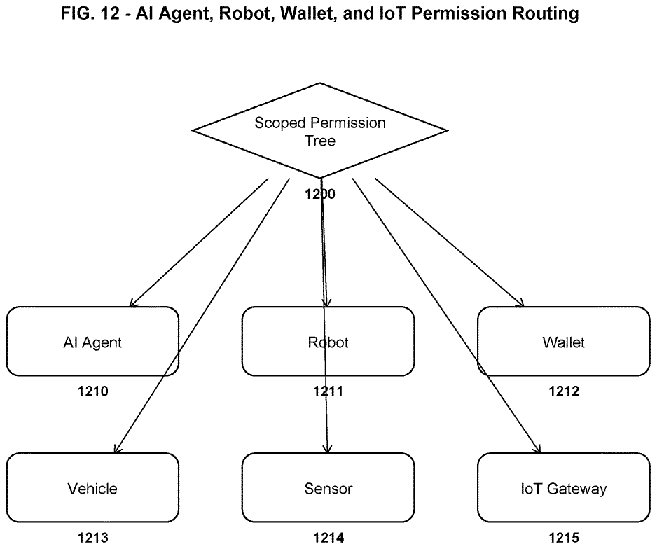

### Implementation of FIG. 12: AI Agent, Robot, Wallet, and IoT Permission Routing

FIG. 12 shows a non-limiting implementation of AI Agent, Robot, Wallet, and IoT Permission Routing. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The AI agent, robot, wallet, and IoT permission routing implementation uses a scoped permission tree. Before a machine endpoint is activated, the terminal checks whether the requesting BEI-ID, agent, robot, wallet, vehicle, sensor, or gateway is within scope. The scope may be limited by domain, time, task type, service class, authority level, safety policy, privacy level, value limit, or route score threshold.

This implementation protects AI-agent and device automation from becoming uncontrolled execution. An authorized AI agent may assist with routine routing, but the ActionLedger can record that the event was agent-assisted and identify the authorization path. A robot or IoT endpoint may execute only when its scope matches the intention vector, permission state, and temporal trust route result.

The implementation shown in FIG. 12 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

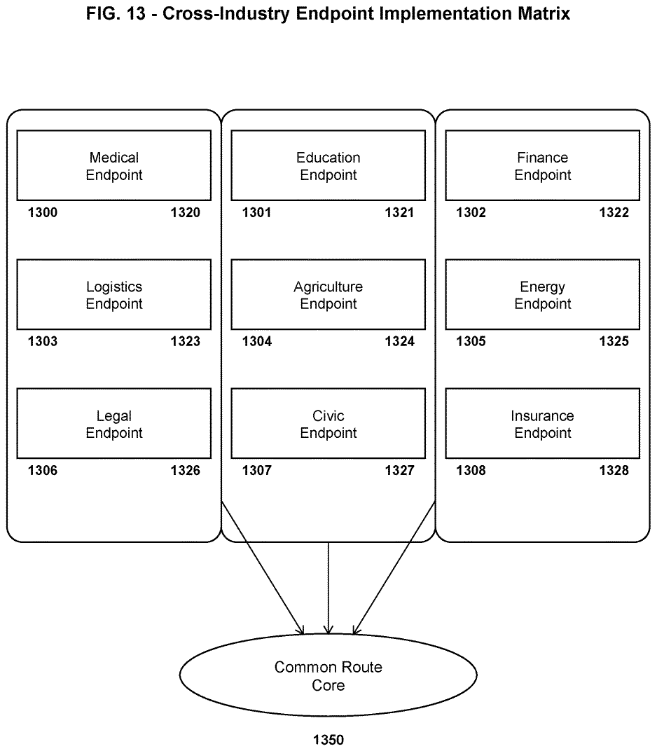

### Implementation of FIG. 13: Cross-Industry Endpoint Implementation Matrix

FIG. 13 shows a non-limiting implementation of Cross-Industry Endpoint Implementation Matrix. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The cross-industry endpoint implementation matrix shows that the same common route core can be applied to medical, education, finance, logistics, agriculture, energy, legal, civic, insurance, and other domains. Each industry endpoint may use different data, validators, policies, and service outputs while preserving the shared relationship among BEI identity, rooted domain, intention vector, temporal trust graph, route score, activation, and evidence.

This matrix supports licensing and asset-package value because different licensees can implement different industry modules without losing the common corridor. A hospital, school, bank, logistics provider, energy company, insurer, public service organization, or legal service platform may license a portion of the stack while still interoperating through domain-linked evidence and relay structures.

The implementation shown in FIG. 13 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

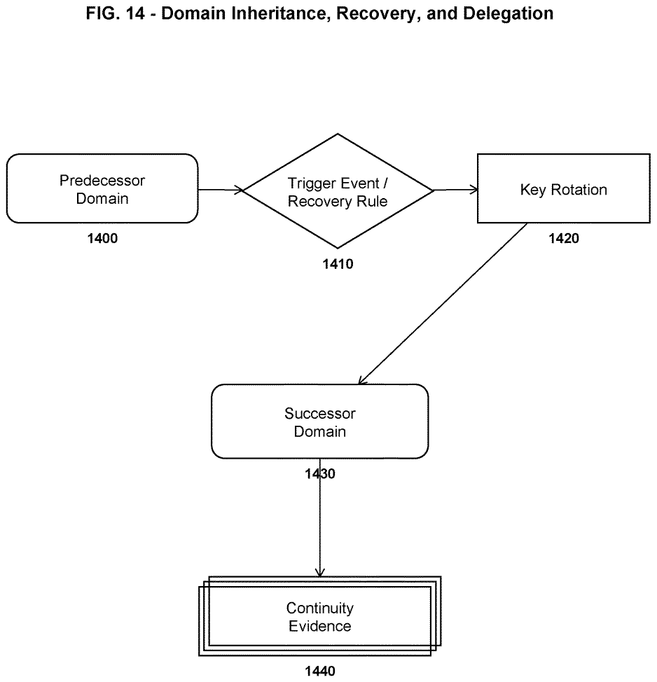

### Implementation of FIG. 14: Domain Inheritance, Recovery, and Delegation

FIG. 14 shows a non-limiting implementation of Domain Inheritance, Recovery, and Delegation. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The domain inheritance, recovery, and delegation implementation allows a predecessor domain or identity node to transfer selected rights, records, permissions, terminal modules, or continuity evidence to a successor domain or identity node. A trigger event or recovery rule may require guardian confirmation, institutional confirmation, multi-party validation, time delay, signature verification, key rotation, or ledger review.

The inheritance mechanism differs from copying an account because it preserves source domain, BEI identity, time, permission, trust, and evidence metadata. Selected records can be transferred while private records remain restricted. The mechanism supports family continuity, enterprise continuity, community disaster recovery, professional succession, and institutional memory while maintaining auditability.

The implementation shown in FIG. 14 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

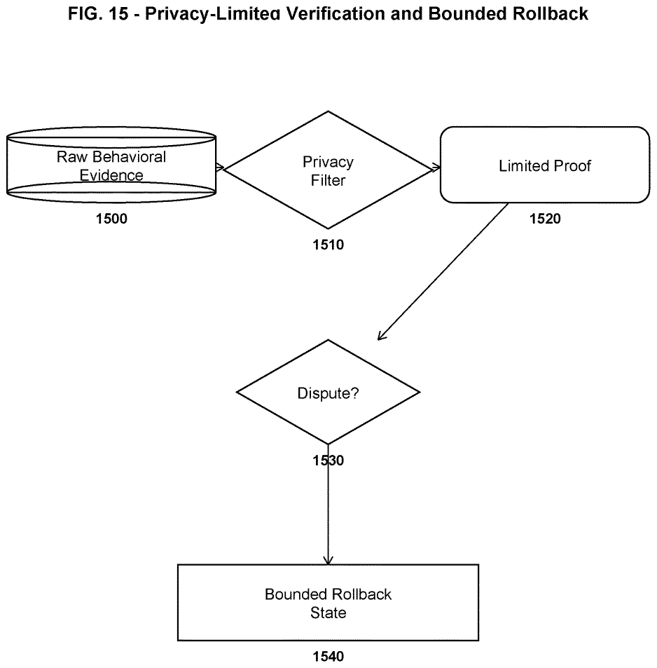

### Implementation of FIG. 15: Privacy-Limited Verification and Bounded Rollback

FIG. 15 shows a non-limiting implementation of Privacy-Limited Verification and Bounded Rollback. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

Privacy-limited verification and bounded rollback allow the system to prove route state, trust vector, permission state, or signed evidence without disclosing raw behavioral evidence beyond the required scope. A privacy filter may transform raw behavioral evidence into a limited proof. If a dispute is detected, a bounded rollback state may reverse or constrain a route, value event, permission state, or trust update without destroying the underlying audit trail.

This structure reduces the risk that a domain terminal becomes a single public profile containing all data. Different modules can reveal different levels of proof. A health route may disclose only authorization and time, a finance route may disclose settlement evidence, a governance route may disclose decision records, and a recovery route may disclose continuity evidence subject to policy.

The implementation shown in FIG. 15 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

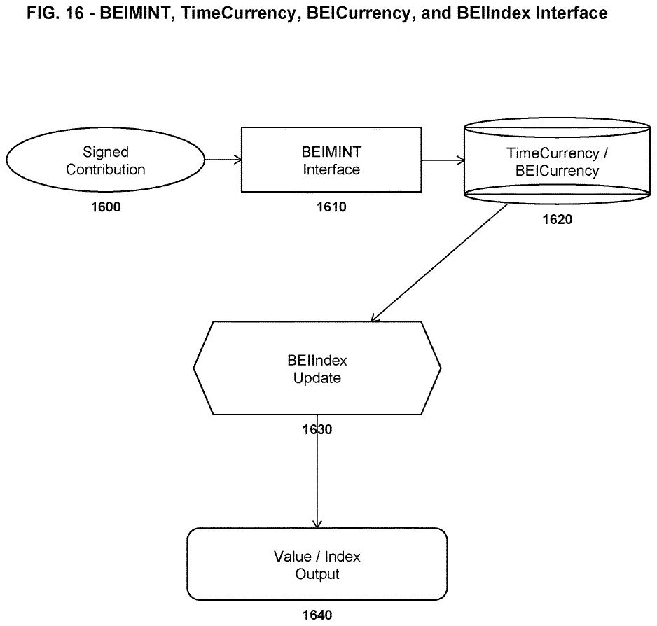

### Implementation of FIG. 16: BEIMINT, TimeCurrency, BEICurrency, and BEIIndex Interface

FIG. 16 shows a non-limiting implementation of BEIMINT, TimeCurrency, BEICurrency, and BEIIndex Interface. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The BEIMINT, TimeCurrency, BEICurrency, and BEIIndex interface allows a signed contribution or validated behavior to be communicated to value and index modules. The interface may produce a time token, trust token, credit, voucher, settlement record, wallet entry, TimeCurrency unit, BEICurrency unit, BEIMINT record, BEIIndex update, or other value representation derived from signed route or service evidence.

The interface is not claimed merely as an abstract reward. The value representation is derived from a validated event tied to BEI identity, rooted domain, time, source, validator, permission basis, and ledger-state information. The route from intention to value includes identity confirmation, time binding, behavior validation, endpoint activation, ledger entry, trust update, and value/index interface generation.

The implementation shown in FIG. 16 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

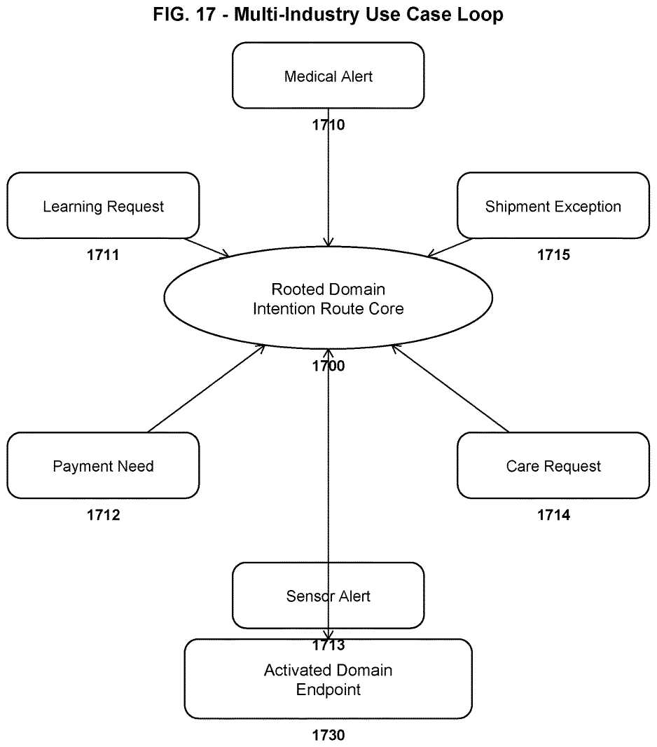

### Implementation of FIG. 17: Multi-Industry Use Case Loop

FIG. 17 shows a non-limiting implementation of Multi-Industry Use Case Loop. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The multi-industry use case loop shows how medical alerts, learning requests, payment needs, sensor alerts, care requests, shipment exceptions, and other events may be routed through a common rooted domain intention route core. The activated endpoint may be a human service, institutional service, software module, wallet interface, robot instruction, IoT command, registry update, or cross-domain relay.

The use case loop demonstrates that the invention is not limited to one industry or domain string. It protects the technical route corridor by which identity, intention, time, trust, permission, endpoint capability, activation, and evidence are coupled. Industry examples illustrate deployment and licensing paths rather than claim limitations unless expressly recited.

The implementation shown in FIG. 17 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

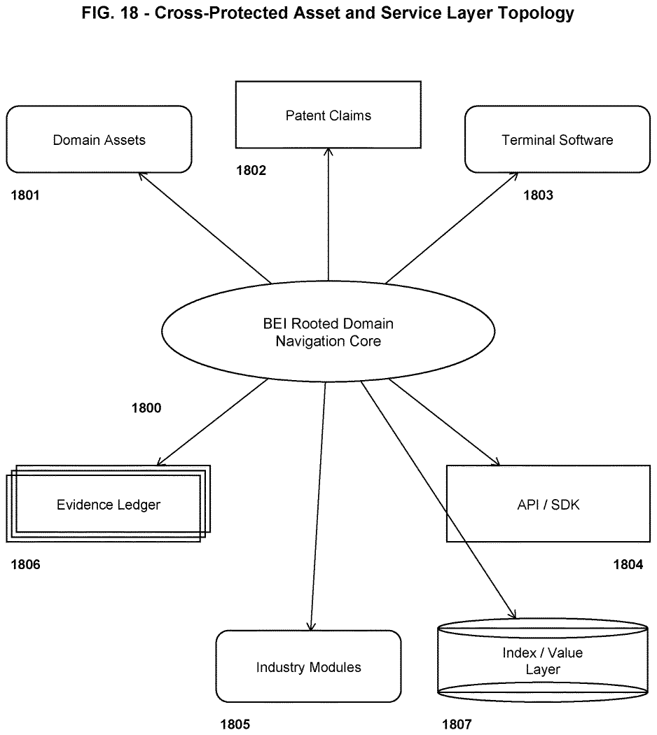

### Implementation of FIG. 18: Cross-Protected Asset and Service Layer Topology

FIG. 18 shows a non-limiting implementation of Cross-Protected Asset and Service Layer Topology. The illustrated components are functional modules that may be implemented by processors, memory, network interfaces, secure storage, local caches, domain resolution services, API services, ledgers, device gateways, or combinations thereof. The drawing should be read together with the claims, in which the required features are defined by the recited modules and data relationships rather than by a particular user interface shape.

The cross-protected asset and service layer topology illustrates how domain assets, patent claims, terminal software, API or SDK, industry modules, evidence ledger, and index/value layer can cooperate. This topology supports asset packaging because a single product may use only one layer, while a complete deployment may use the full stack. The strongest protection arises when the layers operate together as a rooted domain BEI navigation and activation system.

The topology also supports anti-design-around analysis. If a competing service uses different branding but retains a domain-like identity root, intention-based endpoint routing, temporal trust scoring, signed evidence, and terminal activation, the technical passage remains aligned with the disclosed architecture. If a competitor removes one layer, it may reduce functionality and licensing value.

The implementation shown in FIG. 18 is non-limiting. Components may be combined, divided, executed in different order, deployed centrally or locally, implemented in cloud or edge systems, or integrated with external services, provided that the claimed relationships among rooted domain identity, BEI behavioral economic identity, intention navigation, temporal trust routing, endpoint activation, and signed evidence are maintained.

### Operational Workflows

A typical operational workflow begins when a user, family, institution, AI agent, wallet, robot, vehicle, sensor, IoT device, or service terminal enters or triggers a request event. The terminal converts the request into an intention vector. The identity layer verifies the BEI-ID and rooted domain. The temporal layer assigns time context. The permission layer evaluates policy scope and privacy flags. The route engine computes a temporal trust routing score for candidate endpoints. The activation layer activates the selected endpoint. The evidence layer stores signed route and service records. The feedback layer updates trust and future route priority.

A medical workflow may begin when a patient or family terminal enters an intention to seek care, organize records, contact an expert, schedule a service, or activate a family support route. The system identifies the rooted domain terminal, verifies the BEI-ID, places the request into a time context, identifies endpoint class and urgency, evaluates medical resource endpoints, activates a selected service or professional endpoint, records the action, and updates trust, value, or index records as appropriate. A geographic map may be called only when a physical destination is required.

An education workflow may begin when a learner, teacher, mentor, institution, or AI agent declares an intention to learn, teach, certify, validate, schedule, or relay a credential. The system routes the intention to an education endpoint, evaluates prior behavior, identifies validators or resources, records learning or validation actions in the ActionLedger, and updates a credential, trust state, or value representation. The rooted domain terminal preserves continuity across platforms and institutions.

A finance or wallet workflow may begin when a payment need, authorization request, settlement task, value conversion request, or contribution record is generated. The system verifies domain identity, scoped wallet permission, time context, route score, dispute state, and service capability before causing a wallet call or clearing interface. The ActionLedger can record the signed permission basis, selected endpoint, settlement evidence, and value or index state update.

A logistics or IoT workflow may begin when a shipment exception, sensor alert, device telemetry event, vehicle status, energy demand, agriculture sensor event, or gateway request is received. The intention vector identifies urgency, endpoint class, service class, and policy scope. Candidate endpoints may include human operators, institutional endpoints, device gateways, robots, vehicles, or service APIs. The routing score selects an endpoint, activation causes a command or message, and the evidence record preserves identity, domain, time, permission, and result.

A recovery workflow may begin when a user loses device access, domain access, wallet access, terminal control, or key control. The terminal evaluates recovery rules including guardian confirmation, institutional proof, time delay, inherited keys, signature verification, peer receipt, and ledger review. A recovery event is recorded, sensitive routes may be temporarily constrained, and successful recovery can rotate keys or delegate selected rights while preserving continuity evidence.

An inheritance workflow may begin when a scheduled transfer, family rule, organizational succession, life-stage event, institutional confirmation, or emergency trigger occurs. The system verifies predecessor and successor identities, validates permission and time requirements, identifies transferable rights or records, records transfer evidence, and updates the successor domain or BEI-ID. The transfer may be limited to selected records, modules, proofs, or permissions while preserving privacy.

An offline workflow begins when a local terminal receives a request or service event while disconnected. The terminal stores local timestamp, source, provisional identity state, intention vector, route score, selected endpoint, local signature, peer receipt, conflict flag, and ledger-state hash. Upon reconnection, the synchronization process checks duplicates, missing records, signature status, time ordering, permission priority, Merkle proof, and conflict rules before writing or reconciling the final ledger record.

An inter-domain relay workflow begins when a source domain terminal packages a credential, proof, value object, terminal instruction, service record, or index update with metadata. The target terminal receives the package and checks source domain, BEI-ID, time, signature, trust state, permission, privacy scope, and expiration. If accepted, the target terminal records the relay and may activate a service or value route. If rejected or disputed, a rejection or review state is recorded.

A deployment workflow begins when a family, school, clinic, association, enterprise, community, or disaster-response organization deploys a terminal seed-kit. The system creates initial modules, roles, local caches, trust policies, endpoint directories, and synchronization settings. Members are onboarded as BEI-ID nodes. The organization can then route local intentions to medical, education, governance, recovery, finance, logistics, or public-service modules while preserving auditability.

### Technical Effects and Advantages

The invention improves identity processing by replacing isolated static accounts with a rooted domain-linked BEI-ID that carries time, behavior, trust, terminal state, permission state, route history, and relay context. This improves continuity across platforms and reduces repeated re-identification. The rooted domain terminal also provides an addressable namespace for organizing service modules and evidence records.

The invention improves navigation by routing intentions through identity, time, behavior, trust, permission, endpoint capability, and signed evidence. A conventional map may identify a physical path, but the present navigation engine identifies an appropriate service path. The system can navigate to people, institutions, terminal modules, records, credentials, resources, machine endpoints, value events, and index updates, not merely to a geographic location.

The invention improves computer network operation by replacing a static name-to-address lookup with a verified identity-to-intention-to-trust-to-endpoint routing procedure. The system changes machine state by generating intention vectors, computing route scores, activating endpoints, writing signed evidence, caching records, reconciling conflicts, updating TrustScore, and updating value or index interfaces.

The invention improves data integrity by recording behavior and service events in an ActionLedger with time, source, validator, status, permission, signature, and ledger-state metadata. Offline events can be cached and later reconciled. Disputed events can be marked rather than overwritten. This provides auditability and continuity in environments where platform logs or network access are unreliable.

The invention improves access control by using a scoped permission tree, TrustScore, route score, and temporal validity. A route can be selected according to what an identity node is permitted to do, not merely what the node requests. Permissions may be domain-limited, module-limited, time-limited, value-limited, privacy-limited, agent-limited, robot-limited, wallet-limited, or recovery-limited.

The invention improves portability by using inter-domain relay. A behavioral asset, credential, service proof, value record, or terminal instruction can move from one domain terminal to another while preserving metadata necessary for verification. This supports cross-institutional and cross-geographic use without requiring every system to share the same central platform.

The invention improves resilience by supporting local-first and offline-compatible operations. A terminal can continue to record behavior, emergency events, care actions, device events, service tasks, or community decisions even when connectivity is limited. Later resynchronization can preserve continuity and enable conflict review.

The invention improves modular deployment by enabling separated licensing and implementation of the identity layer, navigation layer, terminal layer, evidence layer, trust layer, offline synchronization layer, inheritance/recovery layer, AI/device permission layer, and value/index interface. A licensee may implement one layer or the complete stack while preserving the common route corridor.

The invention improves value processing by tying value representations to validated behavior and time. Rather than awarding arbitrary points, the system records the behavior, validation, identity, domain, permission, time, route, endpoint, and ledger context that support a BEIMINT record, TimeCurrency unit, BEICurrency unit, trust token, time token, credit, or BEIIndex update.

The invention improves anti-design-around protection because the protected corridor does not depend on one commercial name. A competitor may call the process smart matching, AI routing, contextual dispatch, medical navigation, wallet authorization, IoT command routing, or service orchestration. If the implementation uses rooted domain identity, intention vector, temporal trust graph, routing score, endpoint activation, and signed evidence, it follows the disclosed technical passage.

### 101 Eligibility Support

The disclosed architecture is tied to particular networked machines, domain-linked terminals, processors, memory, endpoint directories, permission engines, routing score engines, activation engines, offline trust vaults, synchronization services, and signed evidence ledgers. The technical improvement is not the statement of a desired result, but the ordered processing by which an identity-bound request is authenticated, converted into an intention vector, scored against a temporal trust graph, activated through a domain terminal, recorded as signed evidence, synchronized when needed, and audited or updated through subsequent trust, value, or index states.

The disclosed system is directed to a concrete technical architecture, not to a disembodied idea. The claims are supported by specific components including rooted domain identity binding, BEI-ID state generation, intention vector generation, temporal trust graph maintenance, domain endpoint retrieval, route score computation, permission verification, domain terminal activation, ActionLedger evidence storage, offline synchronization, and value or index interface updating. These components cooperate to improve computing and network operation in identity, routing, permission, synchronization, and endpoint execution.

The navigation process is not merely a mental step because it uses machine-readable identity, domain, time, behavior, trust, endpoint, permission, cryptographic verification, and terminal state to compute routes and update records. A person could not practically perform cross-domain identity verification, temporal trust scoring, endpoint directory retrieval, permission enforcement, signed evidence storage, offline reconciliation, and inter-domain relay at network scale as a mental process.

The value interface features are not claimed as a mere economic practice. The value representation arises from technical processing of validated behavior or service events. The event is bound to BEI-ID, rooted domain, time, source, validator, permission basis, route score, endpoint identifier, signature, and ledger-state hash before any value or index logic is applied. The technical steps provide auditability and route enforcement that are not present in ordinary commercial arrangements.

The system improves a technological process because the domain name is not used only as a website label. It is used as an executable identity and routing root. The system transforms a request event into an intention vector, uses temporal trust routing to select an endpoint, activates a domain terminal, and writes signed evidence. This ordered combination changes how network resources are identified, authorized, activated, and audited.

### 112 Written Description and Enablement Support

The disclosure provides written description support by defining the major modules and explaining their relationships. A person of ordinary skill in computer networking, identity management, service routing, domain name systems, database systems, cryptographic verification, distributed ledger systems, API integration, and device communication can implement the system using conventional programming languages, APIs, databases, authentication libraries, domain resolution infrastructure, message queues, ledger systems, and device interfaces.

The disclosure enables multiple embodiments without undue experimentation. The system can be implemented centrally, distributed, hybrid, cloud-based, edge-based, local-first, or mobile-first. The BEI-ID may use keys, credentials, accounts, signatures, behavioral records, or institutional proofs. The rooted domain may use public DNS, private namespace, subdomain structure, domain alias, registry handle, or decentralized namespace identifier. The ActionLedger may use a conventional database, append-only log, hash chain, distributed ledger, local ledger, or signed event stream.

The disclosure avoids indefiniteness by defining BEI-ID, rooted domain name, domain terminal, intention vector, temporal trust graph, RTTNav, TimeNav, ActionLedger, TrustScore, domain terminal activation, inter-domain relay, and value representation. These terms identify technical functions and data relationships. Particular examples, industry names, domain examples, figures, and endpoint categories are non-limiting and do not narrow the invention unless recited in a claim.

The input-processing-output relationships are described throughout the specification. For example, a request event is received, an intention vector is generated, a temporal state is determined, candidate endpoints are retrieved, permission is verified, a temporal trust routing score is computed, a selected endpoint is activated, and signed route evidence is stored. This sequence provides clear support for system, method, and non-transitory computer-readable medium claims.

### 102 Novelty Support

The novelty of the disclosed architecture lies in the ordered combination of rooted domain identity, BEI behavioral identity state, intention vector generation, temporal trust graph, domain endpoint retrieval, routing score engine, domain terminal activation, ActionLedger evidence, TrustScore feedback, offline trust vault, scoped permission tree, inheritance and recovery logic, privacy-limited verification, value/index interface, and cross-domain relay. Known identity systems, mapping systems, social networks, service directories, wallets, or ledgers may include isolated pieces, but they do not disclose the same integrated domain-rooted identity navigation and terminal activation structure.

A conventional map navigation system does not teach a route beginning from a rooted domain BEI-ID and proceeding through intention vector generation, temporal state determination, temporal trust graph scoring, permission verification, domain endpoint activation, signed ActionLedger evidence, and cross-domain relay. A conventional single-sign-on system does not teach temporal trust routing or domain terminal modules. A conventional wallet does not teach multi-industry domain terminal routing through behavior-ledger trust.

The invention differs from ordinary domain hosting. A domain name in the disclosed system is not merely a web address; it is a root trust anchor and namespace for identity, terminal modules, ledger events, permissions, inheritance keys, endpoint routing, privacy-limited verification, and relay objects. The system uses the domain root as part of a technical process for routing, validating, activating, and recording behavior.

The invention also differs from ordinary AI recommendation. A recommendation may suggest a service, but the disclosed system verifies rooted domain identity, generates machine-readable intention state, computes temporal trust route scores, enforces permission scope, activates an endpoint, and records signed evidence. The route result changes machine state and future routing behavior through TrustScore, ActionLedger, permission, value, or index updates.

### 103 Non-Obviousness Support

A person of ordinary skill would not be led by ordinary map navigation to create a rooted domain terminal with BEI behavioral identity, temporal trust routing, ActionLedger evidence, offline trust vault, permission-scoped AI/robot/wallet/IoT activation, inheritance and recovery, and value/index interface. Map systems optimize travel routes. Identity systems authenticate users. Ledger systems record events. Domain systems resolve names. The invention combines these fields in a specific structure in which each layer changes the operation of the others.

The combination is not a predictable aggregation because the rooted domain determines terminal namespace and continuity, the BEI-ID supplies behavioral identity, the intention vector supplies route demand state, TimeNav changes selection by temporal context, RTTNav changes selection by trust and relation, the permission tree constrains activation, ActionLedger records the route and result, TrustScore feeds back into future routing, and inter-domain relay makes the resulting object portable. These interactions produce a system effect beyond isolated components.

The offline synchronization and inheritance features further support non-obviousness. A typical platform account is not designed for generational identity transfer or local-first disaster continuity. The disclosed terminal architecture permits a domain-linked identity node to record behavior offline, reconcile records later, rotate keys, transfer selected rights or records, and preserve continuity evidence across nodes.

The value and index interface further supports non-obviousness because value is not attached as a detached reward rule. Value representation is generated from signed contribution evidence that is bound to identity, domain, time, permission, endpoint, and ledger state. The route from intention to value is therefore part of the technical passage rather than a separate business label.

### Cross-Protection and Anti-Design-Around Principles

The invention may be practiced even if a competitor uses different labels for the components. BEI-ID may be called behavioral ID, life ID, domain ID, personal terminal ID, trust ID, or sovereign ID. Intention navigation may be called smart routing, contextual routing, service routing, task routing, health navigation, identity navigation, agent routing, or life navigation. ActionLedger may be called event chain, action log, proof record, trust ledger, evidence ledger, or route ledger. The technical relationship remains the same if a rooted identity, intention state, time context, behavior record, trust state, permission basis, endpoint activation, and signed evidence are used together.

The invention may also be practiced without the exact domain examples disclosed herein. A competitor may use a subdomain, app domain, decentralized domain, internal namespace, institutional naming scheme, private registry, wallet address mapped to a domain terminal, or device gateway namespace. If that namespace functions as the rooted identity terminal for routing intentions, recording behavior, updating trust, enforcing permission, activating endpoints, and relaying terminal records, it follows the disclosed domain-rooted architecture.

The cross-protection strategy covers the identity layer, domain layer, navigation layer, endpoint retrieval layer, route scoring layer, activation layer, evidence layer, trust layer, offline synchronization layer, inheritance layer, recovery layer, privacy verification layer, AI/device permission layer, value/index interface, and inter-domain relay layer. Each layer may be licensed separately, but together they form the strongest corridor.

A design-around that removes one layer may reduce utility, reliability, or licensing value. A design-around that keeps the functional relationships while changing the brand name, module name, endpoint name, namespace format, or industry label may still implement the same technical passage. The specification therefore uses examples to explain the architecture without limiting the claims to a particular commercial domain string or user-facing label.

Example implementation endpoints such as BEINavigator.com, BEINav.app, BEINavigation.com, BEINavigate.com, IntentionNav.com, or IntentionNavigation.com may be used to present a domain terminal, application entry point, navigation system description, action-oriented route, or intention navigation engine. The endpoint name is not the invention. The invention is the technical relationship among rooted domain identity, BEI-ID, intention vector, temporal trust routing, endpoint activation, ActionLedger evidence, TrustScore feedback, and value or index interface.

### Industrial Applicability and Licensing Applications

The invention may be applied to personal data terminals, medical coordination, eldercare coordination, education credentialing, finance, insurance, logistics, agriculture, energy, legal services, civic services, disaster recovery, cross-border communication, family inheritance, machine endpoint permissions, wallet clearing, AI-agent tool routing, robot task routing, Internet-of-Things command routing, and behavioral value exchange. The modular architecture allows a licensee to adopt only the identity layer, navigation layer, terminal layer, evidence layer, or value interface, or to deploy the complete system.

A health system may license the rooted domain terminal and intention navigation layer to route patients, families, caregivers, professionals, devices, and medical records to appropriate services. An education system may license the self-certification and knowledge validation layer. A bank, wallet, or exchange system may license the behavior-ledger value layer. A logistics operator may license endpoint routing and evidence records. A public service organization may license trust-grid routing and offline recovery. A disaster-response organization may license the offline trust vault and terminal seed-kit layer.

The asset-package value is strengthened because the system is not a single app. It is a stack of interrelated modules: rooted domain identity, BEI-ID, intention navigation, temporal routing, domain endpoint retrieval, route score engine, terminal activation, ActionLedger, TrustScore, scoped permissions, inheritance, recovery, offline trust vault, AI/robot/wallet/IoT permission routing, privacy-limited verification, BEIMINT, TimeCurrency, BEICurrency, BEIIndex, and cross-domain relay.

The patent licensing path can be divided into product licenses, platform licenses, API licenses, SDK licenses, industry-module licenses, endpoint-directory licenses, evidence-ledger licenses, identity/permission licenses, and value/index interface licenses. This modular licensing strengthens negotiation because a potential licensee can adopt a limited layer while still recognizing the value of the full rooted domain BEI navigation corridor.

The invention supports company asset valuation because it links domain assets, patent claims, terminal software, API or SDK components, industry modules, evidence ledger, value/interface layer, and index layer. The disclosed topology allows asset packages to show how domain names are not merely addresses but implementation points for a patented identity, routing, activation, evidence, and value infrastructure.

### ALTERNATIVE EMBODIMENTS

In one alternative embodiment, the domain terminal is implemented as a mobile application with a domain alias. The user does not need to manually type the domain name. The application resolves the rooted domain or domain-based terminal address in the background, verifies BEI-ID state, generates intention vectors, retrieves candidate endpoints, and records route evidence. The system still records events by BEI-ID, domain, time, behavior, permission, and trust state.

In another alternative embodiment, the domain terminal is implemented as a private namespace inside an institution. A hospital, school, enterprise, public-service organization, or community may use an internal root naming system. The internal namespace may later relay selected records to public domain endpoints if permitted. This embodiment shows that the invention is not limited to public Internet domains while preserving the rooted domain-like identity terminal function.

In another alternative embodiment, the intention vector is generated by an authorized AI agent. The user may speak, type, select, or permit the agent to infer an intent from context. The agent submits a structured intention vector to the navigation layer. The route is constrained by BEI-ID, rooted domain, time, permission, trust, privacy, and terminal state. The ActionLedger can record that the route was agent-assisted and identify the authorization path.

In another alternative embodiment, the ActionLedger is implemented as a relational database with append-only event tables. In another embodiment, the ledger is implemented as a hash chain, Merkle tree, directed acyclic graph, signed event stream, local ledger, or distributed ledger. In each case, the event record includes sufficient metadata to preserve source, time, domain, identity, intention, endpoint, permission, verification, and status.

In another alternative embodiment, TrustScore is not a single number. It may be a vector, graph, matrix, permission state, policy value, route priority, edge weight, or set of weights. Different modules may calculate different trust states. A BEI-ID may therefore have different trust profiles for medical, education, finance, governance, logistics, recovery, wallet, robot, IoT, and value exchange functions.

In another alternative embodiment, inter-domain relay uses signed credentials, API payloads, encrypted packages, ledger references, non-fungible credentials, value objects, or token-like records. The relay mechanism is equivalent if it transfers a behavioral or terminal asset with source, identity, time, permission, trust, and evidence metadata between domain terminals or external systems.

In another alternative embodiment, privacy-limited verification uses zero-knowledge proof, hash commitment, selective disclosure credential, encrypted package, limited proof object, redacted evidence package, or auditor-controlled disclosure. The proof mechanism is equivalent if it allows verification of a route state, trust state, permission state, or evidence state without disclosing raw behavioral evidence beyond the required scope.

In another alternative embodiment, the system uses external map systems, identity providers, healthcare systems, educational platforms, payment rails, blockchains, AI models, cloud platforms, or device vendors as subordinate services. Integration with those systems does not eliminate the invention because the BEI terminal remains the identity, intention, time, trust, permission, evidence, and endpoint coordination layer.

### Best Mode and Practical Deployment

A preferred practical deployment uses a public or private rooted domain as the terminal root, a BEI-ID registry as the identity layer, a web and mobile terminal as the user interface, an intention router as the service selector, a temporal trust service as the route scoring engine, an ActionLedger as the event record, a permission tree as the authorization boundary, a trust service as the feedback engine, an offline trust vault as the disconnected operation layer, and a relay service as the cross-domain bridge.

The initial deployment may provide a BEI Navigator interface. The interface receives user intentions and routes them to terminal modules. A medical module, education module, finance module, insurance module, logistics module, energy module, legal module, civic module, recovery module, wallet interface, robot interface, AI-agent tool interface, or IoT gateway may be activated depending on the intention vector and route score. Each module reports results back to the ledger and trust engine.

The preferred implementation avoids unnecessary central dependence. A central service may support convenience, but local cache and domain-linked terminal records allow continuity. In a disaster, travel period, remote area, or low-connectivity environment, a terminal can preserve route and service records and later reconcile them. This supports practical reliability while preserving auditability and continuity.

The preferred implementation avoids confining the invention to one brand, domain, industry, public blockchain, AI model, map provider, cloud platform, or device vendor. Example domain names may be used as implementation endpoints, but the architecture is broader. The invention covers a rooted domain identity and navigation system capable of supporting many service fields, machine endpoints, and licensing models.

The preferred implementation uses the system claim, method claim, and non-transitory computer-readable medium claim together. The system claim protects the architecture, the method claim protects operational processing, and the non-transitory computer-readable medium claim protects software and terminal implementations. Dependent claims then cover binding records, behavioral identity vectors, permission trees, intention vector fields, graph nodes, graph edges, endpoint directories, terminal activation actions, route evidence packages, TrustScore updates, non-geographic routing, offline caching, reconciliation, scoped machine permissions, industry implementations, value/index interfaces, and privacy-limited verification.

### Integrated Hard Technical Passage

In an integrated embodiment, the system processes a rooted domain request as a structured technical passage. The passage begins with a BEI identity reference and a signed domain-terminal binding record. The binding record may include a root domain label, subdomain service namespace, terminal identifier, controller role, routing policy, service pointer, key identifier, validity metadata, and signature. This record allows the routing engine to determine whether the request is associated with a personal terminal, family terminal, enterprise terminal, institutional terminal, public-service terminal, artificial-intelligence-agent terminal, wallet terminal, robot terminal, vehicle terminal, sensor terminal, or Internet-of-Things gateway.

The intention vector may include an intent class, demand category, urgency value, confidence value, time window, service class, endpoint class, policy scope, privacy flag, and domain-routing preference. The temporal trust graph may include nodes representing users, families, enterprises, medical resources, education resources, financial resources, logistics resources, agriculture resources, energy resources, insurance resources, legal resources, governance resources, artificial-intelligence agents, robots, wallets, vehicles, sensors, registry nodes, and service terminals. Edges of the temporal trust graph may include trust weight, validation status, service response latency, dispute outcome, time-decay value, permission relation, availability state, endpoint capacity, and service-quality value.

The routing score engine may compute a temporal trust routing score from urgency, temporal validity, trust weight, permission fit, endpoint availability, service capability, historical service quality, dispute status, privacy requirement, domain priority, and synchronization state. A selected endpoint may be activated by an application programming interface call, wallet call, artificial-intelligence-agent tool call, Internet-of-Things command, robot instruction, message notification, service reservation, emergency alert, registry operation, or cross-domain relay. The ActionLedger may then store a signed route evidence record including the BEI identity reference, domain identifier, intention vector hash, selected endpoint identifier, permission basis, route score, timestamp, cryptographic verification value, and ledger-state hash.

This passage protects the necessary corridor rather than a single industry example. A competitor may call the process smart matching, AI routing, health navigation, logistics dispatch, insurance triage, robotics task selection, wallet authorization, IoT command routing, contextual service matching, or identity-based service dispatch. If the system uses a rooted domain identity, intention vector, temporal trust graph, routing score, endpoint activation, and signed route evidence to activate a service endpoint, the technical passage remains the same even if commercial vocabulary changes.

In another integrated embodiment, the system updates at least one of a behavioral identity vector, permission tree, TrustScore, value representation, or BEIIndex state according to the route result. The update may be written to a local cache and later reconciled, or it may be written directly to an ActionLedger. The update is linked to the evidence record, so a later route can consider past service completion, failure, dispute, delay, privacy requirement, or validation state.

In another integrated embodiment, the system enforces scoped permission before allowing an AI agent, robot, wallet, vehicle, sensor, or IoT gateway to act. Permission may be derived from the BEI-ID, rooted domain, terminal role, time window, policy scope, value limit, safety rule, guardian rule, institution rule, or trust threshold. If the permission does not match, the terminal may reject the action, request additional validation, or route to a review endpoint. The rejection or review can also be recorded as signed evidence.

In another integrated embodiment, a domain-linked route is not selected solely by geographic distance. The route may be selected by trust proximity, intention proximity, permission proximity, temporal proximity, endpoint capability, privacy fit, and route evidence quality. A physically closer endpoint may be rejected if permission is missing, trust is stale, service capability is insufficient, dispute state is active, or privacy scope is incompatible. A physically remote endpoint may be selected if it has stronger trust, capability, availability, and permission fit.

In another integrated embodiment, the same route core supports multiple industries while preserving industry-specific policies. A medical route may require care consent and professional confirmation; an education route may require peer or expert validation; a finance route may require wallet permission and settlement evidence; a logistics route may require vehicle, sensor, and delivery state; a civic route may require role and time window; a recovery route may require guardian confirmation and delayed key rotation. The underlying BEI domain identity navigation passage remains common.

### Additional Detailed Implementation Support for Rooted Domain BEI Navigation

### Detailed Operation of the Rooted Domain Identity Layer

The rooted domain identity layer receives data associated with domain labels, subdomain service namespaces, domain-based terminal addresses, registry handles, decentralized namespace identifiers, controller roles, routing policies, service pointers, key identifiers, validity metadata, and signatures. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the rooted domain identity layer is not merely descriptive; it changes route eligibility, endpoint selection, activation authority, evidence generation, or later trust calculation.

The rooted domain identity layer retrieves data associated with domain labels, subdomain service namespaces, domain-based terminal addresses, registry handles, decentralized namespace identifiers, controller roles, routing policies, service pointers, key identifiers, validity metadata, and signatures. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the rooted domain identity layer is not merely descriptive; it changes route eligibility, endpoint selection, activation authority, evidence generation, or later trust calculation.

The rooted domain identity layer binds data associated with domain labels, subdomain service namespaces, domain-based terminal addresses, registry handles, decentralized namespace identifiers, controller roles, routing policies, service pointers, key identifiers, validity metadata, and signatures. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the rooted domain identity layer is not merely descriptive; it changes route eligibility, endpoint selection, activation authority, evidence generation, or later trust calculation.

The rooted domain identity layer enforces data associated with domain labels, subdomain service namespaces, domain-based terminal addresses, registry handles, decentralized namespace identifiers, controller roles, routing policies, service pointers, key identifiers, validity metadata, and signatures. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the rooted domain identity layer is not merely descriptive; it changes route eligibility, endpoint selection, activation authority, evidence generation, or later trust calculation.

For the rooted domain identity layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The rooted domain identity layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Bei Behavioral Identity State Layer

The BEI behavioral identity state layer receives data associated with timestamped behavioral events, terminal interaction patterns, permission invocation events, service interactions, device telemetry, AI-agent interactions, wallet interactions, and cross-node communication events. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the BEI behavioral identity state layer is not merely descriptive; it changes route eligibility, endpoint selection, activation authority, evidence generation, or later trust calculation.

The BEI behavioral identity state layer retrieves data associated with timestamped behavioral events, terminal interaction patterns, permission invocation events, service interactions, device telemetry, AI-agent interactions, wallet interactions, and cross-node communication events. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the BEI behavioral identity state layer is not merely descriptive; it changes route eligibility, endpoint selection, activation authority, evidence generation, or later trust calculation.

The BEI behavioral identity state layer binds data associated with timestamped behavioral events, terminal interaction patterns, permission invocation events, service interactions, device telemetry, AI-agent interactions, wallet interactions, and cross-node communication events. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the BEI behavioral identity state layer is not merely descriptive; it changes route eligibility, endpoint selection, activation authority, evidence generation, or later trust calculation.

The BEI behavioral identity state layer enforces data associated with timestamped behavioral events, terminal interaction patterns, permission invocation events, service interactions, device telemetry, AI-agent interactions, wallet interactions, and cross-node communication events. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the BEI behavioral identity state layer is not merely descriptive; it changes route eligibility, endpoint selection, activation authority, evidence generation, or later trust calculation.

For the BEI behavioral identity state layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The BEI behavioral identity state layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Intention Navigation Layer

The intention navigation layer receives data associated with request events, context extraction, demand classification, intention vectors, urgency values, confidence values, time windows, service classes, endpoint classes, policy scopes, privacy flags, and domain-routing preferences. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the intention navigation layer is not merely descriptive; it changes route eligibility, endpoint selection, activation authority, evidence generation, or later trust calculation.

The intention navigation layer retrieves data associated with request events, context extraction, demand classification, intention vectors, urgency values, confidence values, time windows, service classes, endpoint classes, policy scopes, privacy flags, and domain-routing preferences. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the intention navigation layer is not merely descriptive; it changes route eligibility, endpoint selection, activation authority, evidence generation, or later trust calculation.

The intention navigation layer binds data associated with request events, context extraction, demand classification, intention vectors, urgency values, confidence values, time windows, service classes, endpoint classes, policy scopes, privacy flags, and domain-routing preferences. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the intention navigation layer is not merely descriptive; it changes route eligibility, endpoint selection, activation authority, evidence generation, or later trust calculation.

The intention navigation layer enforces data associated with request events, context extraction, demand classification, intention vectors, urgency values, confidence values, time windows, service classes, endpoint classes, policy scopes, privacy flags, and domain-routing preferences. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the intention navigation layer is not merely descriptive; it changes route eligibility, endpoint selection, activation authority, evidence generation, or later trust calculation.

For the intention navigation layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The intention navigation layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Temporal Trust Graph Layer

The temporal trust graph layer receives data associated with user nodes, family nodes, enterprise nodes, institutional nodes, AI-agent nodes, robot nodes, wallet nodes, vehicle nodes, sensor nodes, service nodes, registry nodes, and time-decayed edge weights. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the temporal trust graph layer is not merely descriptive; it changes route eligibility, endpoint selection, activation authority, evidence generation, or later trust calculation.

The temporal trust graph layer retrieves data associated with user nodes, family nodes, enterprise nodes, institutional nodes, AI-agent nodes, robot nodes, wallet nodes, vehicle nodes, sensor nodes, service nodes, registry nodes, and time-decayed edge weights. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the temporal trust graph layer is not merely descriptive; it changes route eligibility, endpoint selection, activation authority, evidence generation, or later trust calculation.

The temporal trust graph layer binds data associated with user nodes, family nodes, enterprise nodes, institutional nodes, AI-agent nodes, robot nodes, wallet nodes, vehicle nodes, sensor nodes, service nodes, registry nodes, and time-decayed edge weights. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the temporal trust graph layer is not merely descriptive; it changes route eligibility, endpoint selection, activation authority, evidence generation, or later trust calculation.

The temporal trust graph layer enforces data associated with user nodes, family nodes, enterprise nodes, institutional nodes, AI-agent nodes, robot nodes, wallet nodes, vehicle nodes, sensor nodes, service nodes, registry nodes, and time-decayed edge weights. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the temporal trust graph layer is not merely descriptive; it changes route eligibility, endpoint selection, activation authority, evidence generation, or later trust calculation.

For the temporal trust graph layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The temporal trust graph layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Endpoint Directory Layer

The endpoint directory layer receives data associated with DNS records, subdomain records, registry records, decentralized namespace records, service pointer records, local terminal caches, mesh-node directories, peer-receipt directories, institutional directories, and device registries. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the endpoint directory layer is not merely descriptive; it changes route eligibility, endpoint selection, activation authority, evidence generation, or later trust calculation.

The endpoint directory layer retrieves data associated with DNS records, subdomain records, registry records, decentralized namespace records, service pointer records, local terminal caches, mesh-node directories, peer-receipt directories, institutional directories, and device registries. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the endpoint directory layer is not merely descriptive; it changes route eligibility, endpoint selection, activation authority, evidence generation, or later trust calculation.

The endpoint directory layer binds data associated with DNS records, subdomain records, registry records, decentralized namespace records, service pointer records, local terminal caches, mesh-node directories, peer-receipt directories, institutional directories, and device registries. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the endpoint directory layer is not merely descriptive; it changes route eligibility, endpoint selection, activation authority, evidence generation, or later trust calculation.

The endpoint directory layer enforces data associated with DNS records, subdomain records, registry records, decentralized namespace records, service pointer records, local terminal caches, mesh-node directories, peer-receipt directories, institutional directories, and device registries. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the endpoint directory layer is not merely descriptive; it changes route eligibility, endpoint selection, activation authority, evidence generation, or later trust calculation.

For the endpoint directory layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The endpoint directory layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Routing Score Layer

The routing score layer receives data associated with urgency, temporal validity, trust weight, permission fit, endpoint availability, service capability, historical service quality, dispute status, privacy requirement, domain priority, and synchronization state. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the routing score layer is not merely descriptive; it changes route eligibility, endpoint selection, activation authority, evidence generation, or later trust calculation.

The routing score layer retrieves data associated with urgency, temporal validity, trust weight, permission fit, endpoint availability, service capability, historical service quality, dispute status, privacy requirement, domain priority, and synchronization state. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the routing score layer is not merely descriptive; it changes route eligibility, endpoint selection, activation authority, evidence generation, or later trust calculation.

The routing score layer binds data associated with urgency, temporal validity, trust weight, permission fit, endpoint availability, service capability, historical service quality, dispute status, privacy requirement, domain priority, and synchronization state. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the routing score layer is not merely descriptive; it changes route eligibility, endpoint selection, activation authority, evidence generation, or later trust calculation.

The routing score layer enforces data associated with urgency, temporal validity, trust weight, permission fit, endpoint availability, service capability, historical service quality, dispute status, privacy requirement, domain priority, and synchronization state. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the routing score layer is not merely descriptive; it changes route eligibility, endpoint selection, activation authority, evidence generation, or later trust calculation.

For the routing score layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The routing score layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Domain Terminal Activation Layer

The domain terminal activation layer receives data associated with API calls, wallet calls, AI-tool calls, IoT commands, robot instructions, message notifications, service reservations, emergency alerts, registry operations, and cross-domain relays. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the domain terminal activation layer is not merely descriptive; it changes route eligibility, endpoint selection, activation authority, evidence generation, or later trust calculation.

The domain terminal activation layer retrieves data associated with API calls, wallet calls, AI-tool calls, IoT commands, robot instructions, message notifications, service reservations, emergency alerts, registry operations, and cross-domain relays. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the domain terminal activation layer is not merely descriptive; it changes route eligibility, endpoint selection, activation authority, evidence generation, or later trust calculation.

The domain terminal activation layer binds data associated with API calls, wallet calls, AI-tool calls, IoT commands, robot instructions, message notifications, service reservations, emergency alerts, registry operations, and cross-domain relays. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the domain terminal activation layer is not merely descriptive; it changes route eligibility, endpoint selection, activation authority, evidence generation, or later trust calculation.

The domain terminal activation layer enforces data associated with API calls, wallet calls, AI-tool calls, IoT commands, robot instructions, message notifications, service reservations, emergency alerts, registry operations, and cross-domain relays. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the domain terminal activation layer is not merely descriptive; it changes route eligibility, endpoint selection, activation authority, evidence generation, or later trust calculation.

For the domain terminal activation layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The domain terminal activation layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Actionledger Evidence Layer

The ActionLedger evidence layer receives data associated with signed route evidence, signed service evidence, permission events, value events, dispute events, recovery events, contribution events, ledger-state hashes, signatures, and status values. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the ActionLedger evidence layer is not merely descriptive; it changes route eligibility, endpoint selection, activation authority, evidence generation, or later trust calculation.

The ActionLedger evidence layer retrieves data associated with signed route evidence, signed service evidence, permission events, value events, dispute events, recovery events, contribution events, ledger-state hashes, signatures, and status values. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the ActionLedger evidence layer is not merely descriptive; it changes route eligibility, endpoint selection, activation authority, evidence generation, or later trust calculation.

The ActionLedger evidence layer binds data associated with signed route evidence, signed service evidence, permission events, value events, dispute events, recovery events, contribution events, ledger-state hashes, signatures, and status values. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the ActionLedger evidence layer is not merely descriptive; it changes route eligibility, endpoint selection, activation authority, evidence generation, or later trust calculation.

The ActionLedger evidence layer enforces data associated with signed route evidence, signed service evidence, permission events, value events, dispute events, recovery events, contribution events, ledger-state hashes, signatures, and status values. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the ActionLedger evidence layer is not merely descriptive; it changes route eligibility, endpoint selection, activation authority, evidence generation, or later trust calculation.

For the ActionLedger evidence layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The ActionLedger evidence layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Offline Trust Vault Layer

The offline trust vault layer receives data associated with local route events, local service events, local signatures, peer receipts, conflict flags, cached route scores, selected endpoints, Merkle proofs, and reconciliation states. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the offline trust vault layer is not merely descriptive; it changes route eligibility, endpoint selection, activation authority, evidence generation, or later trust calculation.

The offline trust vault layer retrieves data associated with local route events, local service events, local signatures, peer receipts, conflict flags, cached route scores, selected endpoints, Merkle proofs, and reconciliation states. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the offline trust vault layer is not merely descriptive; it changes route eligibility, endpoint selection, activation authority, evidence generation, or later trust calculation.

The offline trust vault layer binds data associated with local route events, local service events, local signatures, peer receipts, conflict flags, cached route scores, selected endpoints, Merkle proofs, and reconciliation states. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the offline trust vault layer is not merely descriptive; it changes route eligibility, endpoint selection, activation authority, evidence generation, or later trust calculation.

The offline trust vault layer enforces data associated with local route events, local service events, local signatures, peer receipts, conflict flags, cached route scores, selected endpoints, Merkle proofs, and reconciliation states. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the offline trust vault layer is not merely descriptive; it changes route eligibility, endpoint selection, activation authority, evidence generation, or later trust calculation.

For the offline trust vault layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The offline trust vault layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Privacy And Bounded Rollback Layer

The privacy and bounded rollback layer receives data associated with raw behavioral evidence, privacy filters, limited proofs, dispute flags, bounded rollback states, audit trails, and post-dispute route constraints. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the privacy and bounded rollback layer is not merely descriptive; it changes route eligibility, endpoint selection, activation authority, evidence generation, or later trust calculation.

The privacy and bounded rollback layer retrieves data associated with raw behavioral evidence, privacy filters, limited proofs, dispute flags, bounded rollback states, audit trails, and post-dispute route constraints. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the privacy and bounded rollback layer is not merely descriptive; it changes route eligibility, endpoint selection, activation authority, evidence generation, or later trust calculation.

The privacy and bounded rollback layer binds data associated with raw behavioral evidence, privacy filters, limited proofs, dispute flags, bounded rollback states, audit trails, and post-dispute route constraints. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the privacy and bounded rollback layer is not merely descriptive; it changes route eligibility, endpoint selection, activation authority, evidence generation, or later trust calculation.

The privacy and bounded rollback layer enforces data associated with raw behavioral evidence, privacy filters, limited proofs, dispute flags, bounded rollback states, audit trails, and post-dispute route constraints. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the privacy and bounded rollback layer is not merely descriptive; it changes route eligibility, endpoint selection, activation authority, evidence generation, or later trust calculation.

For the privacy and bounded rollback layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The privacy and bounded rollback layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Value And Index Interface Layer

The value and index interface layer receives data associated with signed contributions, BEIMINT interfaces, TimeCurrency representations, BEICurrency representations, BEIIndex updates, wallet clearing, service payment, reward distribution, resource exchange, and contribution indexing. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the value and index interface layer is not merely descriptive; it changes route eligibility, endpoint selection, activation authority, evidence generation, or later trust calculation.

The value and index interface layer retrieves data associated with signed contributions, BEIMINT interfaces, TimeCurrency representations, BEICurrency representations, BEIIndex updates, wallet clearing, service payment, reward distribution, resource exchange, and contribution indexing. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the value and index interface layer is not merely descriptive; it changes route eligibility, endpoint selection, activation authority, evidence generation, or later trust calculation.

The value and index interface layer binds data associated with signed contributions, BEIMINT interfaces, TimeCurrency representations, BEICurrency representations, BEIIndex updates, wallet clearing, service payment, reward distribution, resource exchange, and contribution indexing. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the value and index interface layer is not merely descriptive; it changes route eligibility, endpoint selection, activation authority, evidence generation, or later trust calculation.

The value and index interface layer enforces data associated with signed contributions, BEIMINT interfaces, TimeCurrency representations, BEICurrency representations, BEIIndex updates, wallet clearing, service payment, reward distribution, resource exchange, and contribution indexing. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the value and index interface layer is not merely descriptive; it changes route eligibility, endpoint selection, activation authority, evidence generation, or later trust calculation.

For the value and index interface layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The value and index interface layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Detailed Operation of the Inter-Domain Relay Layer

The inter-domain relay layer receives data associated with source domains, target domains, actor BEI-IDs, timestamps, signatures, trust states, permission metadata, expiration rules, encrypted packages, API payloads, and ledger references. The layer normalizes the data according to identity state, rooted domain state, temporal state, permission state, trust state, endpoint state, and evidence state. The layer outputs an output that can be consumed by a subsequent module without requiring a centralized platform account. This ordered relationship supports a technical implementation because the output of the inter-domain relay layer is not merely descriptive; it changes route eligibility, endpoint selection, activation authority, evidence generation, or later trust calculation.

The inter-domain relay layer retrieves data associated with source domains, target domains, actor BEI-IDs, timestamps, signatures, trust states, permission metadata, expiration rules, encrypted packages, API payloads, and ledger references. The layer filters the data according to identity state, rooted domain state, temporal state, permission state, trust state, endpoint state, and evidence state. The layer ranks an output that can be consumed by a subsequent module without requiring a centralized platform account. This ordered relationship supports a technical implementation because the output of the inter-domain relay layer is not merely descriptive; it changes route eligibility, endpoint selection, activation authority, evidence generation, or later trust calculation.

The inter-domain relay layer binds data associated with source domains, target domains, actor BEI-IDs, timestamps, signatures, trust states, permission metadata, expiration rules, encrypted packages, API payloads, and ledger references. The layer updates the data according to identity state, rooted domain state, temporal state, permission state, trust state, endpoint state, and evidence state. The layer records an output that can be consumed by a subsequent module without requiring a centralized platform account. This ordered relationship supports a technical implementation because the output of the inter-domain relay layer is not merely descriptive; it changes route eligibility, endpoint selection, activation authority, evidence generation, or later trust calculation.

The inter-domain relay layer enforces data associated with source domains, target domains, actor BEI-IDs, timestamps, signatures, trust states, permission metadata, expiration rules, encrypted packages, API payloads, and ledger references. The layer activates the data according to identity state, rooted domain state, temporal state, permission state, trust state, endpoint state, and evidence state. The layer audits an output that can be consumed by a subsequent module without requiring a centralized platform account. This ordered relationship supports a technical implementation because the output of the inter-domain relay layer is not merely descriptive; it changes route eligibility, endpoint selection, activation authority, evidence generation, or later trust calculation.

For the inter-domain relay layer, a preferred implementation uses deterministic data fields so that an examiner, implementer, or licensee can identify what is received, what is processed, and what is generated. The fields are not required to have the same names in every implementation, but the implementation should preserve the relationship among BEI identity, rooted domain state, intention, time, trust, permission, endpoint, activation, and evidence. This makes the disclosure suitable for software, cloud, mobile, edge, wallet, robot, IoT, and institutional deployments.

The inter-domain relay layer also supports anti-design-around protection. A competing system may describe the same layer as an account layer, namespace layer, identity router, contextual service layer, trust router, dispatch engine, event evidence service, task activator, synchronization system, or value interface. If the layer performs the same rooted-domain BEI navigation function using equivalent data relationships, the technical passage remains within the disclosed architecture.

### Industry-Specific Non-Limiting Implementations

In a medical and eldercare implementation, a symptom event, medical device alert, care request, fall event, medication reminder, second-opinion request, appointment need, or family support request is converted into an intention vector, matched against a temporal trust graph, filtered by permission and privacy requirements, and routed to a clinician endpoint, caregiver endpoint, emergency endpoint, pharmacy endpoint, record-review endpoint, or family support node. The ActionLedger records signed route evidence and service evidence for later audit, billing, trust updating, recovery, and value-index processing.

In an education and credentialing implementation, a learning intention, skill-certification request, mentor search, teaching request, peer-validation event, or credential update is routed to a course endpoint, teacher endpoint, peer validator, school terminal, expert-review endpoint, or credential registry. The same rooted domain route engine preserves identity continuity across platforms and institutions while storing evidence suitable for credential relay and trust-score updating. In a finance, wallet, and clearing implementation, a payment request, wallet authorization, credit proof, settlement need, contribution-clearing event, or service-payment event is processed as a domain terminal activation rather than as an isolated wallet command. A value route may require a higher permission level than an information route and may generate settlement evidence, reward-distribution evidence, resource-exchange evidence, or contribution-indexing evidence.

In a logistics and supply-chain implementation, a shipment exception, warehouse event, vehicle status, delivery request, cold-chain alert, or route disruption is converted into an intention vector and routed to a carrier endpoint, warehouse terminal, vehicle node, delivery agent, proof-of-service endpoint, or exception-review endpoint. The selected endpoint need not be geographically closest; it may be selected because it satisfies trust, capacity, permission, and time-window requirements.

In agriculture and food-system implementations, a field sensor event, irrigation request, soil condition, crop-risk signal, equipment alert, harvest event, or market-routing request is routed through the same BEI identity, temporal trust, and endpoint-activation architecture. The service endpoint may be a farm terminal, water-control endpoint, agronomy service, equipment node, supply endpoint, or market endpoint.

In energy and utility implementations, a meter event, outage report, load-balancing request, storage-state event, device-maintenance alert, or emergency-energy event is routed to a grid endpoint, storage endpoint, technician endpoint, pricing endpoint, emergency route, or device-control endpoint. The system records the authority basis and route evidence so that later audit can identify why a grid, storage, or device operation was allowed.

In insurance and risk-processing implementations, a claim event, risk update, policy check, care-compliance record, damage proof, or fraud-review event is routed to a claim endpoint, adjuster endpoint, verification service, payment endpoint, or risk-review terminal. The route evidence can show the intention vector, permission basis, selected endpoint, and validation status without exposing raw behavioral evidence beyond the required disclosure scope.

In legal and compliance implementations, a consent record, contract event, compliance alert, evidence package, dispute state, notary request, or filing event is routed to a law-office endpoint, notary endpoint, arbitration endpoint, court-filing endpoint, compliance terminal, or review service. Signed non-activation evidence may be generated when a requested route is rejected or escalated due to insufficient authority, expired policy, or privacy constraint.

In civic and community governance implementations, a proposal, vote, resource-allocation request, public-service request, emergency-response need, or local validation event is routed to a community terminal, official endpoint, validator group, emergency coordinator, or public-record ledger. The route may depend on role state, time window, peer validation, dispute status, and domain policy rather than a centralized social feed.

In AI-agent, robot, vehicle, and industrial-device implementations, an authorized agent or machine may generate or submit a request event, but the route engine verifies agent scope, command class, safety state, controller identity, and endpoint authorization before activation. A physical-movement command, payment command, registry command, or safety-critical command may require a higher trust score, human confirmation, or multi-party review.

In Internet-of-Things and sensor-gateway implementations, a sensor alert, firmware event, calibration need, anomaly report, mesh-network message, or gateway command can be converted into an intention vector and associated with a device BEI state. The route may activate a maintenance request, emergency alert, registry operation, data-validator endpoint, or IoT gateway while recording the sensor identity, time, route score, endpoint, and result.

In cross-border and multi-language implementations, language preference, jurisdictional policy, service availability, time-zone state, professional qualification, privacy requirement, and endpoint capability metadata may be used to select an appropriate endpoint. Existing map systems, payment rails, identity providers, healthcare systems, education systems, logistics systems, energy systems, cloud services, and blockchain networks may operate as subordinate service endpoints while the BEI terminal remains the coordinating layer.

The foregoing industry examples share the same necessary corridor: rooted domain identity, BEI identity state, intention vector, temporal trust route, permission verification, endpoint activation, ActionLedger evidence, and feedback update. Industry-specific directories and policies can vary without changing the protected route architecture.

The industry examples also support modular licensing. A licensee may adopt only the domain identity root layer, only the intention navigation layer, only the temporal trust routing layer, only the domain terminal activation layer, only the ActionLedger evidence layer, only the offline synchronization layer, only the AI/IoT permission layer, or only the value-index interface. The complete stack provides the strongest implementation, while partial adoption supports practical commercial transfer and industry-specific deployment.

### Data Records, Fields, and Evidence Packages

A domain-terminal binding record may include root domain label, subdomain service namespace, terminal identifier, controller role, routing policy, service pointer, key identifier, validity metadata, and signature. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

A behavioral identity vector may include behavior-history hash, domain-bound identity value, role state value, trust weight value, permission status value, recovery state value, privacy mode flag, and policy version value. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

An intention vector may include intent class, demand category, urgency value, confidence value, time window, service class, endpoint class, policy scope, privacy flag, and domain-routing preference. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

A candidate endpoint record may include endpoint identifier, endpoint class, domain pointer, service capability, availability state, permission requirement, trust edge reference, dispute flag, and service-quality value. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

A temporal trust routing score record may include urgency component, temporal validity component, trust weight component, permission fit component, availability component, capability component, dispute component, privacy component, domain-priority component, and synchronization component. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

A route evidence package may include candidate endpoint list hash, selected endpoint hash, route score, permission basis, trust edge state, event timestamp, signature, and dispute flag. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

A service evidence package may include service type, endpoint identifier, service start time, service completion state, validation status, user feedback, peer receipt, institutional receipt, and ledger-state hash. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

A offline cache record may include request event, intention vector, local route score, selected endpoint, local signature, peer receipt, conflict flag, synchronization state, and Merkle proof. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

A recovery record may include lost access event, recovery rule, guardian confirmation, institutional confirmation, time delay, signature verification, key rotation, and continuity evidence. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

A value interface record may include signed contribution, BEIMINT reference, TimeCurrency representation, BEICurrency representation, wallet clearing state, reward distribution state, resource exchange state, and BEIIndex update. The listed fields are exemplary and may be encoded as database columns, JSON fields, protocol buffers, ledger entries, signed claims, encrypted payloads, or other machine-readable structures. The technical importance is that the record preserves a relationship among BEI identity, rooted domain state, intention, time, trust, permission, endpoint, activation, and evidence so that later audit, route scoring, privacy verification, recovery, value conversion, or index updating can be performed.

### Additional Route-State, Capability, Review, and Evidence Embodiments

The system may maintain a route-state object for each active request. The route-state object can include a BEI identity reference, rooted domain identifier, terminal identifier, request source, intention vector hash, temporal state, candidate endpoint list hash, selected endpoint identifier, permission basis, temporal trust routing score, activation command, evidence status, and synchronization status. The route-state object provides a compact operational record while the ActionLedger provides long-term signed evidence.

In one implementation, the route-state object is created before endpoint retrieval and is updated after each stage. A first update records identity verification, a second update records temporal state, a third update records permission filtering, a fourth update records endpoint ranking, and a final update records activation and result. If connectivity is lost, the latest route-state object can be placed in the offline trust vault and later reconciled with ActionLedger evidence.

The temporal trust graph may be implemented as a table, graph database, adjacency list, vector index, signed endpoint directory, or hybrid data structure. A graph edge may carry trust weight, availability, latency, policy relation, response history, capacity, expiration, validation status, and dispute status. The route engine can compute a score from these values and store the score basis in a signed evidence package.

The route engine may use deterministic routing rules, machine-learning-assisted ranking, rules plus models, or policy-based scoring. When a model assists ranking, the terminal still records input fields, permission basis, route score, selected endpoint, and signed evidence so that the route does not become an untraceable black box. Model assistance therefore remains bounded by rooted domain identity, BEI state, temporal trust graph, endpoint activation, and ActionLedger evidence.

A route can be rejected or escalated when the system detects insufficient permission, missing endpoint capacity, expired trust state, conflicting domain records, privacy limitations, disputed route history, or an offline state that cannot be reconciled. The rejection may produce signed non-activation evidence identifying the reason for non-activation, the route-state hash, the permission basis, the time, and the review status. This record supports compliance, dispute resolution, user notification, and future route improvement.

The system may support hierarchical route review. A low-risk route may be activated automatically when identity, permission, and endpoint status are satisfied. A medium-risk route may require a second confirmation from a controller, guardian, institution, or peer validator. A high-risk route may require delay, multi-party confirmation, manual review, or limited activation. Risk can be computed from service class, value class, privacy class, emergency status, dispute history, device command class, and domain policy.

A candidate endpoint can be scored before and after a privacy filter is applied. The unfiltered candidate set may include endpoints technically capable of service, while the filtered candidate set removes endpoints that cannot receive protected data under the requesting identity consent scope. The ActionLedger may store a candidate-set hash and a final selection basis without exposing raw private details beyond the required disclosure scope.

The system may support route simulation before activation. A terminal may compute a simulated temporal trust route, display expected endpoint class, estimated response, required permissions, privacy consequences, evidence consequences, and possible escalation rules, and then request user or controller approval. If approval is denied, the system may store a non-activation record or discard the simulation according to policy. Route simulation is useful for finance, legal, healthcare, robotics, and industrial control.

A domain endpoint may expose a capability statement. The capability statement can include service class, operating hours, jurisdiction, device type, professional qualification, endpoint capacity, supported evidence format, privacy level, fee structure, accepted trust threshold, response latency, and validation authority. The endpoint retrieval module compares the capability statement with the intention vector and temporal trust graph to provide an objective technical basis for routing.

A trust edge may expire or decay based on elapsed time, service inactivity, unresolved dispute, changed role, revoked permission, endpoint unavailability, or failed validation. The route engine can lower the score of stale edges and require fresh confirmation for sensitive routes. This improves over static contact lists or fixed access-control lists because the trust graph remains responsive to time and service performance.

The ActionLedger may store evidence at multiple levels of detail. A public audit layer may store hashes, timestamps, and status; a private terminal layer may store route details; and a sealed evidence layer may store sensitive behavioral, medical, financial, household, or legal details. The permission tree determines who may access each layer, allowing auditability without forcing uncontrolled disclosure of raw evidence.

The offline trust vault may preserve route order even when local clocks are uncertain. The vault can store local time, monotonic counter, device clock state, peer receipt time, and later network-confirmed time. During reconciliation, the system may resolve order using timestamp ordering, counter ordering, signature verification, peer confirmation, Merkle proof, domain priority, permission priority, and bounded rollback.

A robot, vehicle, or industrial device may receive an endpoint activation command only after the scoped permission tree authorizes the command class. A sensor alert may be routed automatically, while a physical movement command, payment command, registry command, or safety-critical command may require a higher trust score or human confirmation. The signed evidence record can identify command class, controller identity, device state, route score, and activation result.

A wallet operation may be treated as domain endpoint activation rather than as a separate system. The wallet endpoint can be selected after the request is converted into an intention vector and permission is verified. A payment route, clearing route, reward route, or contribution route may include selected endpoint identifier, amount or value class, trust score, authorization basis, settlement evidence, and ledger-state hash.

A registry operation may also be treated as domain endpoint activation. The route may update a service pointer, renew a domain binding, change a controller role, rotate a key, delegate a namespace, or mark an endpoint inactive. Because such changes can affect future routes, the ActionLedger records the registry operation with a policy basis, timestamp, prior binding hash, new binding hash, and signature.

The system may use route templates for recurring demand classes. A recurring medical check, school assignment, logistics exception, sensor maintenance event, energy demand response, or family care event can use a template containing default endpoint classes, permission requirements, evidence fields, and escalation rules. The template provides a starting structure, while the temporal trust graph and permission engine still adjust each specific route.

A route can create a feedback event even when the service outcome is partial. An endpoint may accept a request but delay completion, reject the request due to capacity, transfer the request to another endpoint, complete only part of the service, or return a dispute state. Each status event can update trust, availability, response history, and route priority, so the terminal learns from actual operation rather than logging only final success or failure.

Commercial domain examples, brand names, and product names are non-limiting endpoint illustrations. Names such as BEI Navigator, BEI Nav, or Intention Navigation can illustrate deployment, but the protected invention is the technical relationship among rooted domain identity, BEI state, intention vector, temporal trust route, endpoint activation, signed evidence, and feedback. This prevents a narrow interpretation based on any particular domain string. The claims are supported by the specification because the system claim maps to the layered architecture, the method claim maps to the operational workflow, and the non-transitory computer-readable-medium claim maps to terminal execution across users, families, institutions, AI agents, wallets, robots, vehicles, sensors, and IoT devices. The drawings support the same elements through architecture, vector generation, graph structure, endpoint retrieval, score computation, activation runtime, signed evidence, offline vault, value interface, and cross-industry endpoint topology.

The final implementation remains broad while technically specific. It does not claim a slogan, business plan, or medical-only platform. It claims a reusable route infrastructure that converts domain-bound BEI identity and request events into authorized endpoint activation and signed evidence. This necessary corridor supports multiple demand classes, multiple industries, and multi-terminal deployment while preserving a concrete machine-implemented structure.

### CONCLUSION

The disclosed invention transforms the role of a domain-linked identity from a static address or platform login into a rooted behavioral economic identity terminal. The terminal receives intentions, processes time and trust, retrieves and scores endpoints, activates service modules, records signed evidence, supports offline synchronization, permits delegation, recovery, and inheritance, enforces scoped permissions, and relays assets across domains.

The invention should be understood as navigation and terminal infrastructure rather than a single consumer application. A map can show where to go, but the disclosed system determines how a verified BEI identity node moves through time, behavior, trust, permissions, resources, services, records, evidence, value, and index states. The rooted domain identity is the anchor, the intention navigation engine is the route generator, temporal trust routing is the score mechanism, domain terminal activation is the execution layer, and ActionLedger with TrustScore provides feedback for continued operation.

The examples, figures, and domain endpoint illustrations are provided to explain the invention and do not limit the claims unless expressly recited. The scope includes equivalent implementations that use different names, software stacks, data structures, domain formats, cloud providers, ledger vendors, AI models, device vendors, or deployment environments while preserving the disclosed relationships among rooted domain identity, BEI Behavioral Economic Identity, intention navigation, temporal trust routing, domain terminal activation, signed evidence, trust updating, offline synchronization, inheritance, recovery, privacy-limited verification, value/index interface, and inter-domain relay.

What is claimed is:

1. A rooted domain name-based behavioral economic identity, intention navigation, temporal trust routing, and domain terminal activation system, comprising:
one or more processors and memory storing instructions executable by the one or more processors;
a rooted domain identity module configured to bind a BEI behavioral economic identity reference to a rooted domain name, a subdomain namespace, a domain-based terminal address, a registry handle, or a decentralized namespace identifier;
a behavioral identity state module configured to generate and update a behavioral identity vector from timestamped behavioral events, terminal interaction patterns, permission invocation events, service interactions, device telemetry, artificial-intelligence-agent interactions, wallet interactions, and cross-node communication events;
an intention navigation module configured to generate an intention vector from a request event associated with a person, family, enterprise, institution, artificial-intelligence agent, robot, wallet, Internet-of-Things device, vehicle, sensor, or service terminal;
a temporal trust routing module configured to maintain a temporal trust graph having nodes representing domain-linked service endpoints and edges representing time-valid trust relationships, permission relationships, availability states, service capability states, response-history states, and dispute states;
a domain endpoint retrieval module configured to retrieve candidate domain-linked service endpoints according to the intention vector and the temporal trust graph;
a routing score engine configured to compute a temporal trust routing score for each candidate domain-linked service endpoint according to at least urgency, temporal validity, trust weight, permission fit, endpoint availability, service capability, historical service quality, dispute status, privacy requirement, and domain priority;
a domain terminal activation module configured to activate a selected domain-linked service endpoint according to the temporal trust routing score; and
an ActionLedger evidence module configured to store a signed route evidence record including at least a BEI identity reference, a domain identifier, an intention vector hash, a selected endpoint identifier, a permission basis, a route score, a timestamp, a cryptographic verification value, and a ledger-state hash; wherein the system routes requests across multiple industry domains by using rooted domain name identity, intention navigation, temporal trust routing, and signed domain-terminal evidence rather than by relying solely on geographic coordinates, static website addressing, or centralized platform recommendation.

2. The system of claim 1, wherein the rooted domain identity module stores a signed domain-terminal binding record including a root domain label, subdomain service namespace, terminal identifier, controller role, routing policy, service pointer, key identifier, validity metadata, and signature.

3. The system of claim 1, wherein the behavioral identity vector includes a behavior-history hash, domain-bound identity value, role state value, trust weight value, permission status value, recovery state value, privacy mode flag, and policy version value.

4. The system of claim 1, wherein the system performs delegation, inheritance, recovery, revocation, or temporary override of a domain-linked permission state by updating a permission tree and recording the update in the ActionLedger evidence module.

5. The system of claim 1, wherein the intention vector includes an intent class, demand category, urgency value, confidence value, time window, service class, endpoint class, policy scope, privacy flag, and domain-routing preference.

6. The system of claim 1, wherein the temporal trust graph includes nodes selected from user nodes, family nodes, enterprise nodes, medical nodes, education nodes, financial nodes, logistics nodes, agriculture nodes, energy nodes, insurance nodes, legal nodes, governance nodes, artificial-intelligence-agent nodes, robot nodes, wallet nodes, vehicle nodes, sensor nodes, and registry nodes.

7. The system of claim 1, wherein each edge of the temporal trust graph includes at least one of a trust weight, validation status, service response latency, dispute outcome, time-decay value, permission relation, availability state, endpoint capacity, or service-quality value.

8. The system of claim 1, wherein the domain endpoint retrieval module retrieves candidate domain-linked service endpoints from DNS records, subdomain records, registry records, decentralized namespace records, service pointer records, local terminal caches, mesh-node directories, or peer-receipt directories.

9. The system of claim 1, wherein the domain terminal activation module activates a selected endpoint by causing at least one of an application programming interface call, wallet call, artificial-intelligence-agent tool call, Internet-of-Things command, robot instruction, message notification, service reservation, emergency alert, registry operation, or cross-domain relay.

10. A computer-implemented method for rooted domain name-based behavioral intention navigation and temporal trust routing, comprising:
receiving, by one or more processors of a domain-linked terminal, a request event associated with a BEI behavioral economic identity reference;
identifying a rooted domain name, subdomain namespace, domain-based terminal address, registry handle, or decentralized namespace identifier associated with the BEI behavioral economic identity reference;
generating an intention vector from the request event;
determining a temporal state associated with the request event, the temporal state including at least a time window, urgency state, scheduled state, emergency state, expiration state, or recurrence state;
retrieving candidate domain-linked service endpoints from one or more domain endpoint directories, service registries, local caches, mesh directories, or decentralized namespace records;
verifying a permission state associated with the BEI behavioral economic identity reference and at least one candidate domain-linked service endpoint;
computing a temporal trust routing score for each candidate domain-linked service endpoint according to the intention vector, the temporal state, trust graph information, permission state, endpoint availability, service capability, response history, and dispute status;
selecting a domain-linked service endpoint based on the temporal trust routing score;
activating the selected domain-linked service endpoint through a domain terminal activation process; and
storing a signed route evidence record in an ActionLedger, the signed route evidence record including at least an intention hash, selected endpoint identifier, permission basis, temporal trust routing score, timestamp, signature, and ledger-state hash.

11. The method of claim 10, further comprising generating a signed route evidence package including a candidate endpoint list hash, selected endpoint hash, route score, permission basis, trust edge state, event timestamp, signature, and dispute flag.

12. The method of claim 10, further comprising updating a trust score for a selected endpoint based on service completion, service failure, response speed, peer receipt, user feedback, validation status, dispute outcome, or time-decay rule.

13. The method of claim 10, further comprising performing non-geographic service routing by ranking candidate endpoints according to trust proximity, intention proximity, permission proximity, temporal proximity, and endpoint capability rather than ranking solely according to latitude and longitude.

14. The method of claim 10, further comprising caching, during a disconnected network state, the request event, intention vector, candidate endpoint state, local route score, selected endpoint, local signature, peer receipt, conflict flag, and ledger-state hash in an offline trust vault.

15. The method of claim 14, further comprising reconciling cached records after network reconnection by applying at least one of a timestamp ordering rule, signature verification rule, quorum confirmation rule, conflict-free replicated data type rule, domain-priority rule, permission-priority rule, Merkle proof rule, or bounded rollback rule.

16. A non-transitory computer-readable medium storing instructions that, when executed by one or more processors of a domain-linked terminal, cause the domain-linked terminal to:
maintain a BEI behavioral economic identity state bound to a rooted domain name or domain-based terminal address;
receive request events from users, families, enterprises, institutions, artificial-intelligence agents, robots, wallets, vehicles, sensors, or Internet-of-Things devices;
generate intention vectors and temporal states from the request events;
retrieve candidate domain-linked service endpoints across a plurality of industry domains;
verify permission states and compute temporal trust routing scores;
activate selected domain-linked service endpoints;
generate signed service event records and signed route evidence records;
store the signed service event records and signed route evidence records in an ActionLedger;
perform offline caching and subsequent synchronization of route evidence and service evidence; and
update at least one of a behavioral identity vector, permission tree, trust score, value representation, or index state according to a route result.

17. The non-transitory computer-readable medium of claim 16, wherein the instructions further cause the domain-linked terminal to enforce artificial-intelligence-agent, robot, wallet, or Internet-of-Things permissions according to a scoped permission tree before allowing an endpoint activation.

18. The non-transitory computer-readable medium of claim 16, wherein the instructions further cause the domain-linked terminal to support industry implementations including medical service routing, education service routing, financial service routing, insurance service routing, logistics service routing, agriculture service routing, energy service routing, eldercare service routing, legal service routing, household service routing, civic service routing, robotic service routing, and Internet-of-Things service routing.

19. The non-transitory computer-readable medium of claim 16, wherein the instructions further cause the domain-linked terminal to generate a value-conversion interface that communicates with BEIMINT, TimeCurrency, BEICurrency, BEIIndex, wallet clearing, service payment, reward distribution, resource exchange, or contribution indexing modules.

20. The non-transitory computer-readable medium of claim 16, wherein the instructions further cause the domain-linked terminal to provide privacy-limited verification of a route state, trust vector, permission state, or signed evidence record without disclosing raw behavioral evidence beyond a required disclosure scope.
